(19) United States
(12) Patent Application Publication
(10) Pub. No.: US 2012/0247958 A1
(43) Pub. Date: Oct. 4, 2012

(54) GEL PROCESSING SYSTEMS FOR ELECTROPHORESIS, IMAGING, AND ANALYSIS, SOFTWARE AND METHODS

(75) Inventors: Timothy Updyke, Temecula, CA (US); Paul Predki, Carlsbad, CA (US); Evangeline Gonzalez, Poway, CA (US); Randall Lowe, Encinitas, CA (US); Tad Simons, Palo Alto, CA (US)

(73) Assignee: LIFE TECHNOLOGIES CORPORATION, Carlsbad, CA (US)

(21) Appl. No.: 13/437,726

(22) Filed: Apr. 2, 2012

Related U.S. Application Data
(60) Provisional application No. 61/471,019, filed on Apr. 1, 2011.

(51) Int. Cl. G01N 27/447

(52) U.S. Cl. 204/457; 204/608

(57) ABSTRACT

The present teachings describe gel processing systems comprising at least an electrophoresis device and a computer system operably linked to perform electrophoresis. Systems of the disclosure may also comprise gel imaging systems, image capture systems, gel illumination systems and/or gel/image analysis systems. A computer system of the disclosure may comprise software components including graphical user interface (GUI) specifications and functional specifications. The disclosure also describes methods for gel processing performed on a gel processing system. Methods of the disclosure may comprise performing electrophoresis and in some embodiments, one or more additional steps, such as imaging, analysis, report generation and transfer of data to external sources. Methods and workflows of the disclosure may be user controlled and customized by using the GUI and other software and hardware functional components of the computer system. Users may input and/or select several parameters for performing electrophoresis/imaging/analysis using the systems and methods of the disclosure.

### CROSS-REFERENCE TO RELATED APPLICATIONS

The present application claims priority to U.S. Provisional Patent Application Ser. No. 61/471,019, filed Apr. 1, 2011, the entire contents of which are incorporated herein by reference.

### FIELD

The present disclosure generally relates to gel processing systems comprising computer systems comprising a computer readable medium comprising computer readable instructions, which, when executed by the computer system, are configured to display on a display and to methods operable for gel processing such as for performing electrophoresis. In some embodiments, gel processing systems comprising computer systems and methods of the disclosure may also be operable to image a gel simultaneously during electrophoresis or image a gel after electrophoresis and may also be further operable to analyze an imaged gel during or after electrophoresis.

### BACKGROUND

Gel electrophoresis is a common procedure for separation of biological molecules, such as DNA, RNA, polypeptides and proteins. In gel electrophoresis, molecules can be separated into bands according to the rate at which an imposed electric field causes them to migrate through a filtering gel. A gel enclosed in a glass tube or sandwiched as a slab between glass or plastic plates can be utilized. Gels have an open molecular network structure, defining pores that are saturated with an electrically conductive buffered solution of a salt. These pores are large enough to enable passage of the migrating macromolecules through the gel.

Polyacrylamide gels are commonly used for electrophoresis. Other gels suitable for electrophoresis include agarose gels and starch gels. Polyacrylamide gel electrophoresis or PAGE is popular because the gels are optically transparent, electrically neutral and can be made with a range of pore sizes. Methods of making PAGE gels are well known. See, for example, B. Hames and D. Rickwood, Gel Electrophoresis of Proteins (2d ed. Oxford University Press, 1990); and A. Andrews, Electrophoresis (2nd ed. Oxford University Press, 1986). In general, stock solutions containing acrylamide monomer, a crosslinker such as bisacrylamide, gel buffers, and modifying agents such as sodium dodecyl sulphate (“SDS”) are prepared. These stock solutions can be stored until a gel is needed. To manufacture a gel, the stock solutions are mixed with water in proportions according to the final desired concentrations of the various constituents. The gel is placed in a chamber in contact with buffer solutions which make electrical contact between the gel and the cathode or anode of an electrical power supply. A sample containing macromolecules and a tracking dye can be placed on top of the gel. An electric potential can be applied to the gel causing the sample macromolecules and tracking dye to migrate toward the bottom of the gel. The electrophoresis is halted just before the tracking dye reaches the end of the gel.

The locations of the bands of separated macromolecules are determined by staining the macromolecules in a sample staining apparatus and then imaging the gel in a separate imaging apparatus. Oftentimes, the image from the imaging apparatus must be manipulated in order to review the results and identify the positions of the various bands. By comparing the distance moved by particular bands in comparison to the tracking dye and macromolecules of known mobility, the mobility of other macromolecules can be determined. Thereby, the size of the macromolecules can then be calculated. Existing methods of electrophoresis require multiple time consuming steps and multiple pieces of large equipment to perform the electrophoresis, the gel staining, the imaging, and the image manipulation/analysis. A need exists in the art for better gel electrophoresis methods and for computer systems and software operable to execute these methods.

### SUMMARY

The present disclosure, in some embodiments, describes gel processing systems comprising computer systems and software relating to gel processing applications. The present disclosure in some embodiments also describes methods for gel processing, gel imaging and analysis. In some embodiments, methods of the disclosure may be executed by a computer system. In some embodiments, methods of the disclosure may be executed by a computer system at least in-part.

The present teachings, in some embodiments, describe a gel processing system comprising at least one computer system and at least one gel electrophoresis device operable to communicate and function with each other. In some embodiments, the electrophoresis device may be an electrophoresis system and may comprise one or more of the following devices and/or systems: a gel electrophoresis device, a gel illumination device/system, a gel image capture device/system, and an image analysis device/system. Computer systems of the disclosure may comprise processors, memory units, computing devices, hardware, and software components including a computer readable medium comprising computer readable instructions, which, when executed by the computer system, are configured to display on a display. In some embodiments, a computer readable medium comprising computer readable instructions, which, when executed by the computer system, are configured to display on a display may comprise software components, such as, but not limited to functional specifications and graphical user interface (GUI) specifications operable to communicate with gel electrophoresis systems.

Methods of gel processing, according to some embodiments of the disclosure, may comprise using software components of a computer system of the disclosure to facilitate a user to enter of a variety of method parameters and functional parameters to perform gel processing. For example, in one embodiment, a method of gel processing according to the disclosure may comprise the steps of running a gel, based on parameters entered and/or selected by a user such as, but not limited to, type of buffers to run a gel, type of gel, current at which a gel is run, molecular weight standards to be used, and/or gel run time, which allow a user to customize a gel processing method. In some embodiments, a method of gel processing as described above may further comprise the steps of imaging a gel and may in some embodiments comprise entering and/or selecting one or more imaging related parameters by a user, such as, but not limited to, exposure time and/or type of fluorescence to be measured. In some embodiments, a method of gel processing may further comprise analyzing of a gel (during the electrophoresis process and/or after the electrophoresis to determine for example features such as, but not limited to, molecular weight of biomolecules separated on a gel) and may allow a user to customize analysis of a gel by inputting and/or selecting parameters such as, but not limited to, molecular weight standards to be used, type of statistical/mathematical analysis desired for electropherogram analysis to determine (e.g. cubic spline curve, log curve). In some embodiments, a method of gel processing may further comprise generating reports of data following analysis of a gel (during the electrophoresis process and/or after the electrophoresis) and may allow a user to customize reports of a gel by inputting and/or selecting parameters such as, but not limited to, selecting gel image layout patters, voltage current graphs, lane by lane analysis, output units for molecular weight curves and/or electropherograms.

Computer systems, software and methods of the disclosure that may be operable to enable a user to perform gel processing methods, such as gel electrophoresis, and may be further operable to facilitate a user to perform image capture and/or image analysis and/or report generation and/or exporting results and/or data to external devices, during or after electrophoresis.

One or more advantages of the systems, software and methods of the present disclosure may comprise automating several steps of gel processing, reduced time for conducting electrophoresis, reduced time for analysis of electrophoresis data, reduced time for viewing gel images, simultaneous imaging of a gel during electrophoresis, simultaneous analysis of electrophoresis data, rapid results, reducing operator caused errors by means of a user friendly GUI and/or having a user input data into sequential steps to avoid missing one or more parameters, and various combinations thereof. While specific advantages have been disclosed hereinabove, it will be understood that various embodiments may include all, some, or none of the previously disclosed advantages. Other technical advantages may become readily apparent to those skilled in the art in light of the teachings of the present disclosure.

These and other features of the present teachings will become more apparent from the detailed description in sections below.

### BRIEF DESCRIPTION OF THE DRAWINGS

A better understanding of the features and advantages of the present disclosure will be obtained by reference to the accompanying drawings, which are intended to illustrate, not limit, the present teachings.

FIG. 1 is a schematic representation of a gel processing system comprising a computer system in operable communication with a gel electrophoresis system in accordance with an embodiment of the present teachings.

FIG. 2A is a schematic representation of an exemplary gel electrophoresis device that may be part of the gel electrophoresis system shown in FIG. 1 in accordance with one embodiment of the present teachings.

FIG. 2B is a schematic representation of an exemplary gel electrophoresis device that may be part of the gel electrophoresis system shown in FIG. 1 in accordance with one embodiment of the present teachings. FIG. 3A is a schematic representation of an exploded perspective view of a gel running assembly in accordance with an embodiment of the present teachings.

FIG. 3 depicts a GUI Keypad showing uppercase characters in accordance with an embodiment of the present teachings.

FIG. 4 depicts a GUI Keypad showing lowercase characters in accordance with an embodiment of the present teachings.

FIG. 5 depicts a GUI Keypad showing special character keys in accordance with an embodiment of the present teachings.

FIG. 6 depicts a GUI Numpad showing numerical characters in accordance with an embodiment of the present teachings.

FIG. 7 depicts a Home Screen of a gel electrophoresis system and may include icons or buttons such as but not limited to Info, Run, Reanalyze, Image and Options in accordance with an embodiment of the present teachings.

FIG. 8 depicts a system information GUI screen obtained by clicking on the Info button on the Home Screen shown in FIG. 7 in accordance with an embodiment of the present teachings.

FIG. 9 depicts a GUI of the Run Screen in accordance with an embodiment of the present teachings.

FIG. 10 depicts a GUI of the Start Screen may comprise buttons such as Door, Power Supply, Imager, Illuminator, Load and Cancel in accordance with an embodiment of the present teachings.

FIG. 11A depicts a GUI of an Electrophoresis Screen depicting a Dual Gel Display screen in accordance with an embodiment of the present teachings.

FIG. 11B depicts a GUI of an Electrophoresis Screen depicting a Single Gel Display screen in accordance with an embodiment of the present teachings.

FIG. 12 depicts a GUI of a Method Select Screen in accordance with an embodiment of the present teachings.

FIG. 13 depicts a GUI of a Method Menu Screen having buttons for further GUI screens such as Run Analysis Protein Standards and Advanced in accordance with an embodiment of the present teachings.

FIG. 14 depicts a GUI of a Methods Run Option Screen in accordance with an embodiment of the present teachings.

FIG. 15 depicts a GUI of a Methods Analysis Option Screen in accordance with an embodiment of the present teachings.

FIG. 16 depicts a GUI of a Method Protein Standards Screen in accordance with an embodiment of the present teachings.

FIG. 17 depicts a GUI of a Method Molecular Weight Standard Screen in accordance with an embodiment of the present teachings.

FIG. 18 depicts a GUI of a Method Quantity Standards Curve Screen in accordance with an embodiment of the present teachings.

FIG. 19 depicts a GUI of a Method Report Options Screen in accordance with an embodiment of the present teachings.

FIG. 20 depicts a GUI of a Method Report Lane Select Screen in accordance with an embodiment of the present teachings.

FIG. 21 depicts a GUI of a Method Advanced Options Screen in accordance with an embodiment of the present teachings.

FIG. 22 depicts a GUI of a Method Copy Screen in accordance with an embodiment of the present teachings.

FIG. 23 depicts a GUI of an Options Screen in accordance with an embodiment of the present teachings.

FIG. 24 depicts a GUI of a Service Screen in accordance with an embodiment of the present teachings.

FIG. 25 depicts a GUI of a Calibration in accordance with an embodiment of the present teachings.

FIG. 26 depicts a GUI of a FTP Setup Screen in accordance with an embodiment of the present teachings.

FIG. 27 depicts an example method in accordance with an embodiment of the present teachings.

FIG. 28 depicts an example method in accordance with an embodiment of the present teachings.

### DETAILED DESCRIPTION OF THE DISCLOSURE

It is to be understood that both the foregoing general description and the following detailed description are exemplary and explanatory only and are not intended to limit the scope of the current teachings. In this application, the use of the singular includes the plural unless specifically stated otherwise. Also, the use of “comprise”, “contain”, and “include”, or modifications of those root words, for example but not limited to, “comprises”, “contained”, and “including”, are not intended to be limiting. Use of “or” means “and/or” unless stated otherwise. The term “and/or” means that the terms before and after can be taken together or separately. For illustration purposes, but not as a limitation, “X and/or Y” can mean “X” or “Y” or “X and Y”.

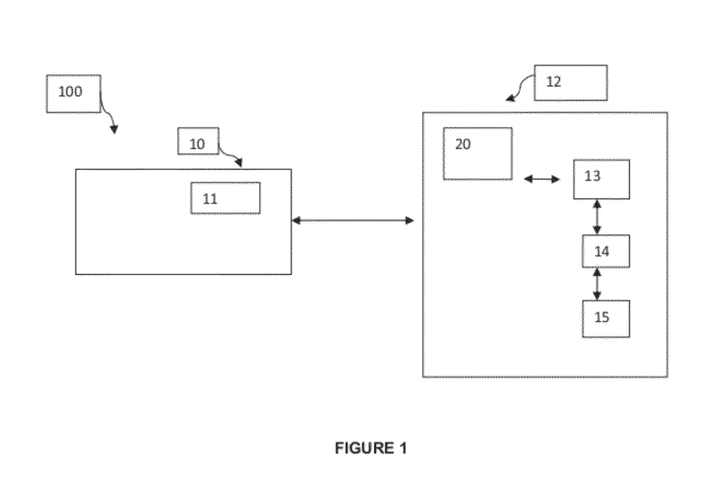

According to various embodiments, the present teachings provide computer systems, software and methods compatible with gel electrophoresis devices. An embodiment of a gel processing system 100 comprising computer system 10 which comprises software 11 and is operable to communicate and function with a gel electrophoresis system 12 comprising a gel electrophoresis device 20 is depicted in FIG. 1. Computer system 10 comprises a computer readable medium comprising computer readable instructions, which, when executed by the computer system, are configured to display on a display.

Although computer system 10 is shown in FIG. 1 as residing as a separate entity physically outside of gel electrophoresis system, one of skill in the art will recognize that computer system 10 and/or components thereof may reside within gel electrophoresis system 12. Accordingly, in some embodiments system 100 may be encompassed in a single housing. In some embodiments, one or more components of system 100 may be encompassed in separate housings.

Gel electrophoresis system 12, may include without limitation one or more devices or systems such as a gel electrophoresis device 20, a gel illumination device/system 13, a gel image capture device/system 14, and an image analysis device/system 15 as shown in FIG. 1. One or more systems and devices of gel processing system 12 may be operably associated with each other. Computer system 10 and components thereof are operably linked with one or more devices and systems of gel processing system 12 and interface with each other.

One of skill in the art, in light of this disclosure, will recognize that the illustrations of gel processing system 100, computer system 10 and/or software 11, gel electrophoresis systems 12, gel electrophoresis devices 20 or 20,′ and/or the methods described herein are not limited to the depictions in FIG. 1 or other figures.

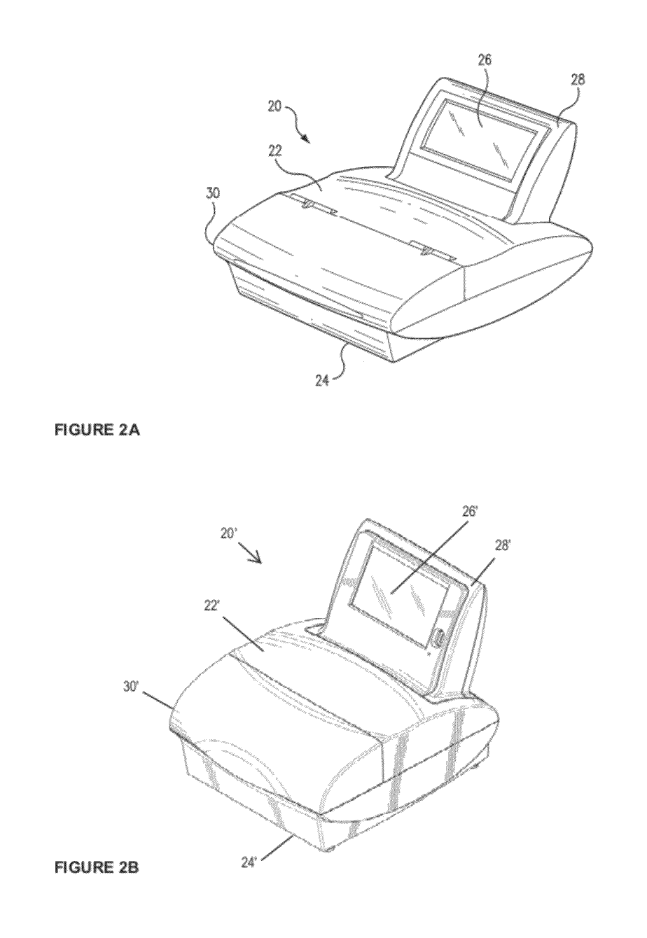

One embodiment of gel electrophoresis device 20 is shown in FIG. 2A comprising a housing 22, a base 24, an LCD display 26, a user interface 28, and a housing lid 30. LCD display 26 may be operably associated with user interface 28. Another embodiment of a gel electrophoresis device 20′ is depicted in FIG. 2B comprising a housing 22′, a base 24′, an LCD display 26′, a user interface 28′, and a housing lid 30′. Devices 20 and 20′ are merely used for illustrative purposes and the systems and methods of the present disclosure may be operable with other gel electrophoresis devices and systems as well.

In some embodiments, a gel electrophoresis device 20 or 20′ may comprise at least one gel buffer reservoir. In some embodiments, a gel electrophoresis device 20 or 20′ comprises at least two gel buffer reservoirs. In some embodiments, at least one gel buffer reservoir may comprise at least one gel holder. In some embodiments, at least one gel buffer reservoir may comprise at least two gel holders. In some embodiments, a gel electrophoresis device 20 or 20′ comprises at least one anode and at least one cathode. In some embodiments, a gel electrophoresis device 20 or 20′ comprises at least one anode and at least one cathode for each of the at least one gel holders. In some embodiments, gel electrophoresis devices of the present teachings, may comprise an integrated gel-based cassette instrument. In some embodiments, a gel electrophoresis device 20 or 20′ may also comprise at least one power supply.

In some embodiments, gel electrophoresis system 100 and computer system 10 may comprise a power supply exhibiting an independent output voltage of from about 0 to about 400 V, for example, 335 V. The power supply may have independent output current of from about 0 to about 0.5 A, for example, 375 mA, and output power is from about 0 to about 200 Watts.

In some embodiments, a gel illumination system 14 may comprise at least one light source. At least one light source may be configured to illuminate at least one electrophoresis gel when the gel is placed in the gel processing system. In some embodiments, at least one light source may comprise at least one blue light source. In some embodiments, at least one light source, emits light in a wavelength range of from about 400 nm to about 800 nm. For example, in some embodiments, at least one light source may emit light in a wavelength range corresponding to blue light (−475 nm). In some embodiments, at least one light source emits light in a wavelength range of from about 500 nm to about 700 nm. In some embodiments, at least one light source emits light in a wavelength range of from about 520 nm to about 640 nm. In some embodiments, at least one light source comprises at least one LED such as, for example purposes only, at least one LED blue light source. In some embodiments, the at least one LED light source comprises multiple LEDs such as, for example purposes only, a blue light source comprising multiple LEDs. In some embodiments, an LED driver may be provided. Any appropriate type of LED may be used. In some embodiments, a Cree XREBLU series LED is used, available from Cree Incorporated, of Durham, N.C. In some embodiments, at least 2, at least 4, at least 8, at least 16, at least 32, at least 40, at least 64 LEDs are used with or without a diffuser.

In some embodiments, the at least one light source may comprise at least two light sources. The gel illumination system may comprise at least one light source for each electrophoresis gel placed in the device. In some embodiments, the gel illumination system may further comprise at least one light-focusing device or at least one light manipulating device. The at least one light focusing device or at least one light manipulating device may be selected from the group consisting of lenses, minors, filters, wave plates, a combination thereof, and the like, or any other suitable light manipulating device. In some embodiments, the at least one light focusing device or at least one light manipulating device may comprise at least one light intensity controlling component. The at least one light intensity controlling component may be configured to control the intensity of the light illuminating a position at which an electrophoresis gel is placed into the device when the device is being used for electrophoresis. In some embodiments, the at least one light source may be pre-configured such that no additional manipulation of the gel illumination system is required, beyond automatic or manual activation of the system. The light source may be configured to provide sufficient illumination for successful image capture at the position at which an electrophoresis gel is placed into the device when the device is being used for electrophoresis.

In some embodiments, a gel image capture system 15 may comprise at least one digital camera. The camera may comprise a complementary metal-oxide-semiconductor (CMOS) device. In some embodiments, the at least one digital camera may comprise at least 1.2 megapixels. In some embodiments, the image capture system may comprise at least one digital camera for each electrophoresis gel placed in the device. In some embodiments, the at least one digital camera may be configured to capture images at the position at which at least one electrophoresis gel is placed in the device when the device is being used for electrophoresis. In some embodiments, the at least one digital camera may be pre-configured such that no additional manipulation of the image capture system is required, beyond automatic or manual activation of the system, to provide successful image capture at the position at which an electrophoresis gel is placed into the device when the device is being used for electrophoresis. In some embodiments, the image capture system may be configured to provide real time imaging of at least one electrophoresis gel during electrophoresis.

Descriptions of gel processing systems and gel electrophoresis systems may also be found in U.S. patent application Ser. No. 12/862,333, filed Aug. 24, 2010, and U.S. Provisional Patent Applications Nos. 61/237,287 filed Aug. 26, 2009, 61/237,195 filed Aug. 26, 2009, 61/236,795 filed Aug. 25, 2009, and 61/236,293 filed Aug. 24, 2009, which are incorporated herein in their entireties by reference. Design of gel electrophoresis systems described here may also be found in concurrently filed U.S. Designs patent application entitled “APPARATUS AND SYSTEMS FOR GEL ELECTROPHORESIS, IMAGING AND ANALYSIS” filed Apr. 1, 2011.

Referring again to FIG. 1, computer system 10, of gel processing system 100, may be functionally associated with gel electrophoresis system 12. Computer system 10 may comprise one or more components such as, but not limited to, a processor unit such as a central processing unit (CPU), hardware, internal storage device having memory, additional memory, software 11, a computer readable medium comprising computer readable instructions, which, when executed by the computer system, are configured to display on a display, a display, a power supply, communication systems, communication interfaces, communication means, a data transfer system such as a read-write CD ROM Drive or a DVD drive, at least one USB port, at least one Ethernet port and/or Application Specific Integrated Circuits (ASICS). In some embodiments, some example communications interfaces may comprise, but are not limited to, USB Type A interfaces, USB Type B interfaces, and RJ-45 sockets.

Computer system 10 and its components are functional to instruct operation of gel processing system 100 including one or more of its devices and components in accordance with pre-programmed and/or user input based instructions, receive data and information from one or more or all components of gel electrophoresis devices and systems, and interpret, manipulate and report the received information to a user. A computer system 10 will be appropriately coupled to gel processing system 100 and components thereof and by means of an analog to digital or a digital to analog converter as needed. Computer system 10 and components thereof may reside within gel electrophoresis system 12 or may reside externally.

Components of computer system 10 may input data from a user into one or more sensors/detectors comprised in various components of gel electrophoresis system 12, and enable interpretation of input data received from a user to initiate further controller instructions to electrophoresis system 12 to conduct one or more steps of electrophoresis and/or image capture and/or image analysis and/or report generation. Components of computer system 10 may also receive data from the one or more sensors/detectors comprised in various components of gel electrophoresis system 12, and interpret the data received into a user understood format to enable a user to monitor progress and/or to obtain additional input from a user to determine the next course of gel processing. Input of data from a user or translation of data received from various devices within gel processing system 100 may be mediated by components of software 11 of computer system 10 which comprises comprising a computer readable medium comprising computer readable instructions, which, when executed by the computer system, are configured to display on a display (screen, LCD).

Software 11 may be operable to receive user instructions, either in the form of user input into a set parameter fields, e.g., in a GUI, or in the form of pre-programmed instructions such as but not limited to pre-programmed instructions for performing a variety of different specific operations and/or for analyzing various parameters and/or for analyzing one or more data components. Software 11, in some embodiments, may be operable to convert pre-programmed instructions to appropriate computer language for instructing operation of system 100 and/or electrophoresis device 20, gel imaging system/device, gel illumination device/system and/or gel analysis systems/device to carry out a desired operation. Software 11, in some embodiments, may be operable to convert data signals or parameters received into appropriate computer language that may then be analyzed by a processor in computer and/or converted into user viewable format for a user to review or analyze.

In some embodiments, software 11 may comprise functional specifications as well as graphical user interface (GUI) specifications. GUI specifications enable user mediated methods. Exemplary GUI's of the present disclosure may comprise some general GUI specifications. In some embodiments, general GUI specifications may comprise all screens, with the exception of pop-up screens, being 800 pixels wide and 480 pixels high.

Other general GUI specifications may include without limitation, the availability of a Home button in all menu screens where Home button allows a user to navigate to a Main Menu; the availability of Breadcrumbs or a Breadcrumb Trail in all menu screens (breadcrumbs may be abbreviated when they are too long for display); the availability of Time and Date in all menu screens; the availability of a Back button in all menu screens where a Back button allows a user to navigate to a previous screen; the availability of a Save button in screens where a user can change and save one or more fields. Breadcrumbs refer to a navigation aid used in a user interface to show the path that a user has taken to arrive at a screen.

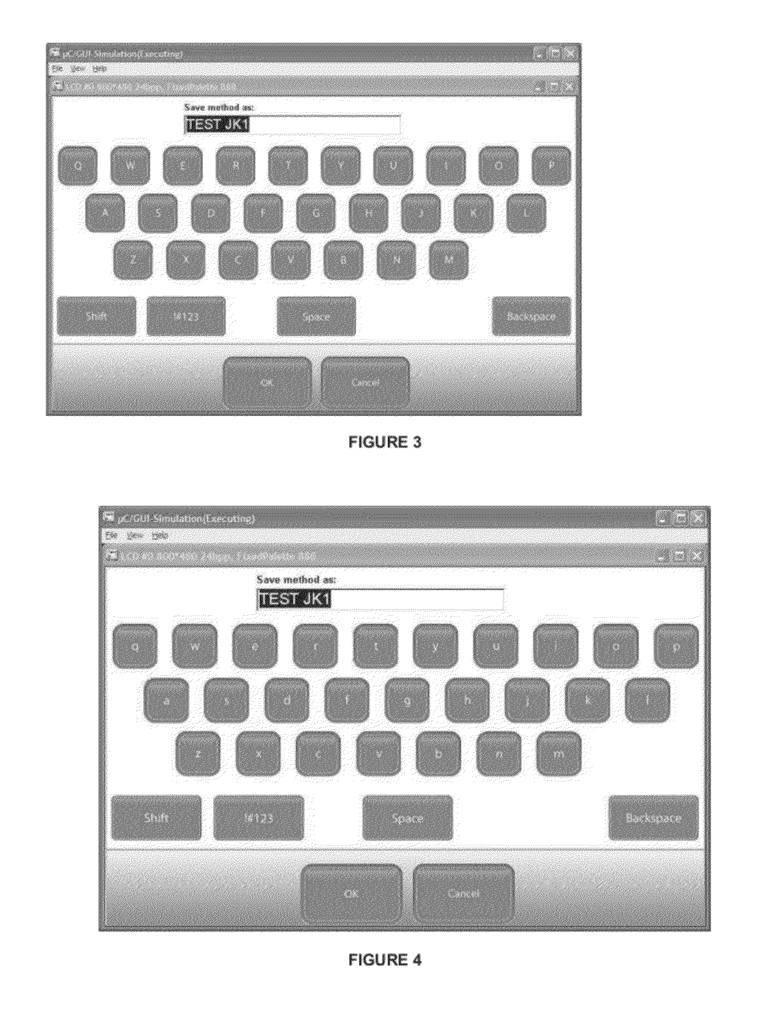

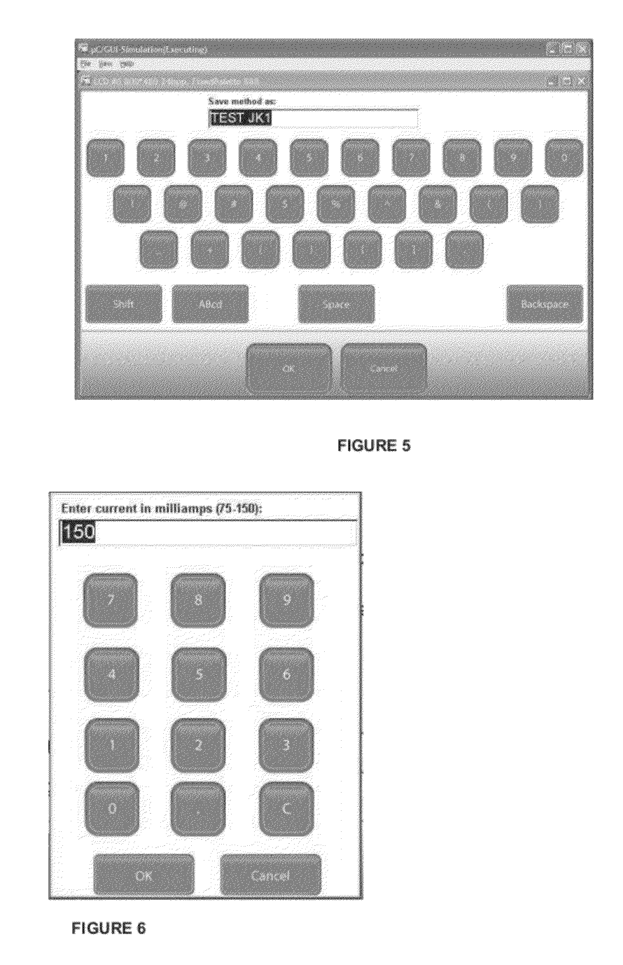

In some embodiments, in a screen where a Save button is available, a Back button may allow a user to either save or cancel a change, if any, before navigating to previous screen. In some embodiments, in a screen where a Save button is available, a Home button allows a user to either save or cancel a change, if any, before navigating to a Home screen. General GUI specifications also include the availability of a Keypad in screens where a user needs to enter an alpha-numeric string or special character keys. FIG. 3 depicts a GUI Keypad showing uppercase characters and FIG. 4 depicts a GUI Keypad showing lowercase characters. FIG. 5 depicts a GUI Keypad showing special character keys:

In some embodiments a general GUI specification also includes a Keypad showing numerical characters also referred to as a Numpad. A Numpad generally displays allowable ranges of numerical values of various parameters that may be entered by a user. Generally a Numpad value is displayed in red if a user input entry is outside an allowable range for the parameter being entered after an OK button is pressed. FIG. 6 depicts a GUI Numpad showing numerical characters.

General GUI specifications also normally include a Help button that takes a user to a Help Screen with optional topics that may be needed to explain the functionality of one or more buttons or screens and how a user may change them.

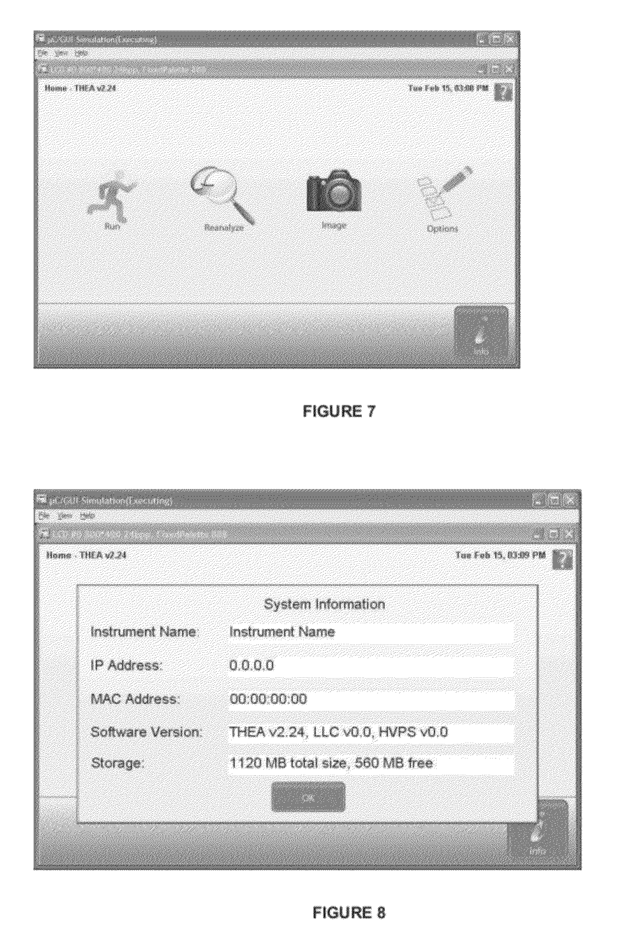

GUI specifications of the disclosure may also comprise Screen Specific Specifications such as those depicted in FIGS. 7-24. FIG. 7 depicts the home screen of a gel electrophoresis device 20 or 20′ and may include icons or buttons such as but not limited to Info, Run, Reanalyze, Image and Options. Upon clicking each of these icons or buttons another GUI screen will appear.

For example, clicking on the Info button on the Home screen allows a user to view system information and brings up a GUI screen as shown in FIG. 8. This may include information such as the name of the Instrument used for gel processing, the IP address the computer address, the version of software and the total storage capacity as well as available storage capacity in the computer memory.

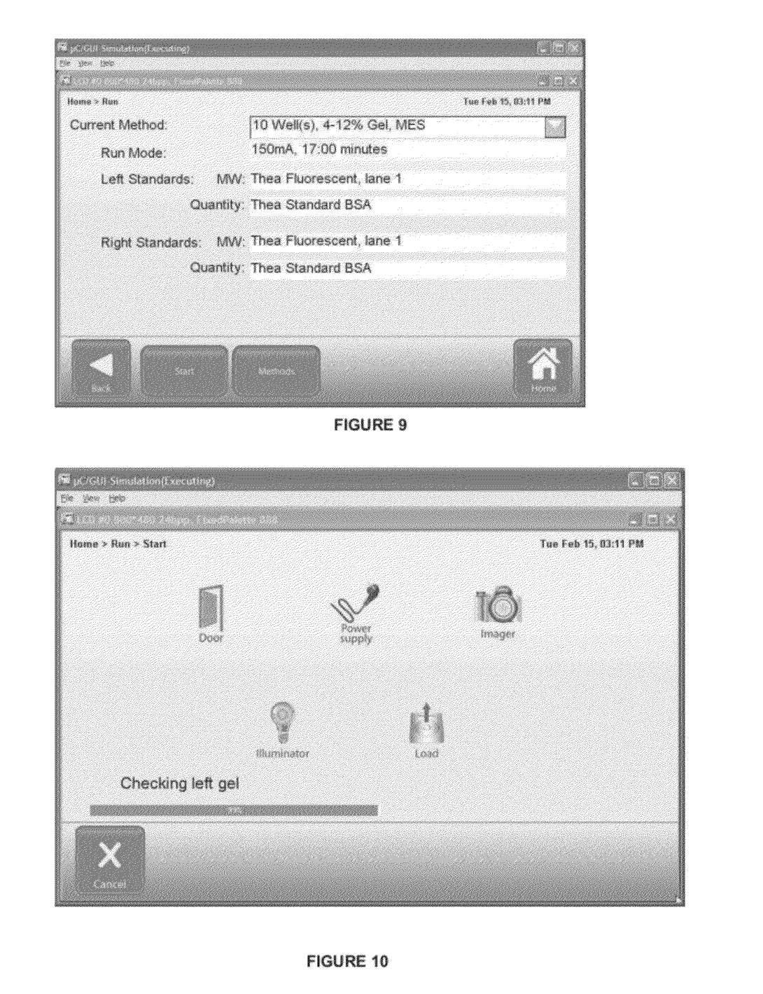

Clicking on the Run button brings up a Run Screen as depicted in FIG. 9. The Run Screen allows a user to input or select a Method to run an experiment such a gel electrophoresis/processing experiment. A Run screen allows a user to view various parameters that may be selected for a Method or an experimental procedure. Some exemplary parameters that may be input or selected include Current Method to enter the name or identity of a method; Run Mode which allows a user to input or select parameters such as current in milliamperes (mA) and the time of the run in minutes (or seconds or hours), a Stop mode; and Left Standards and Right Standards which allow input of molecular weight (MW) standard information for both left and right sides of a gel being processed including MW standard name, lane number in which a MW standard is loaded in a method. A user may also input or select a Quantity standard name, if selected, for both left and right side. These values may be selected from a drop down menu list named Current Method, which may be user input or pre-selected methods. Typically the last run method or last run modified method will be selected as a default method in Run screen unless a user changes the Run parameters.

An exemplary Start screen is depicted in FIG. 10 and may comprise buttons such as Door, Power Supply, Imager, Illuminator, Load and Cancel. The Start screen may also include a status bar that shows the percentage of a run completed using both numeric percentage values and a visual bar filling with a color. A Start screen can be used by a user to perform a system checks prior to starting a gel processing experiment. An exemplary system check may include checking the system to see if the system has more than or equal to 28 MB of internal memory available; if the door is closed; if the communication to LCD is active; if the resistance of each gel loaded falls between 1.0 kOhm and 1.4 kOhm; if the communication to the cameras is active; if the quantity standard is present; if the sample wells of each gel loaded can be located. The Start screen visually shows the progress of each system checks performed prior to starting experiment. The Start screen informs a user and returns to the Run screen in case of any system check failure. The Start screen may also warn a user when a MW standard is not set in a selected Method. A Start screen allows a user to cancel an experiment during system checks.

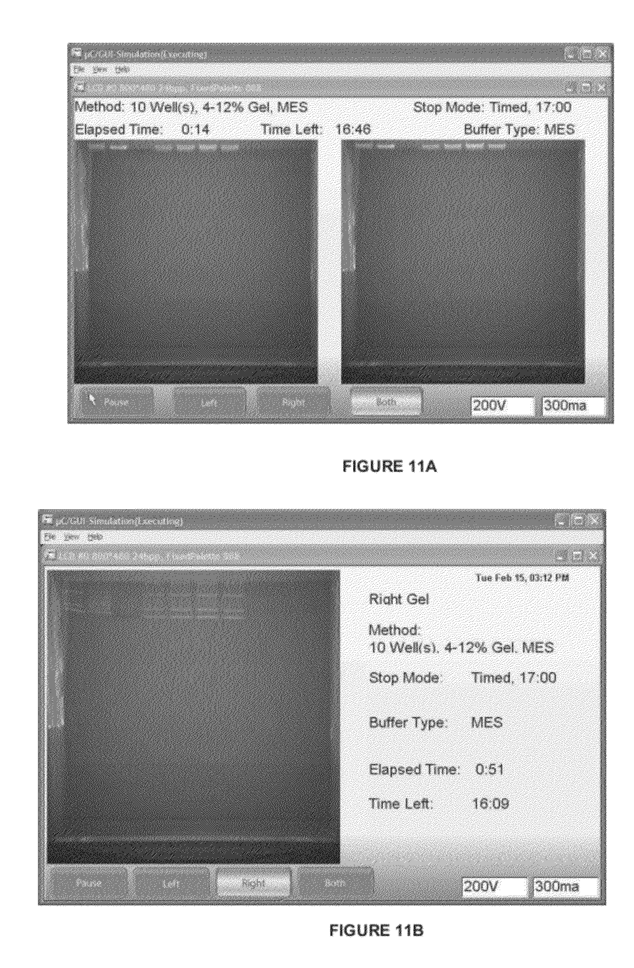

Following a system check the Start screen automatically transitions to an Electrophoresis screen as shown in FIGS. 11A and 11B. An Electrophoresis screen allows a user to select one of the following gel display modes when running two gels: a) a Single Gel Display (See FIG. 11B) depicting only the Left Gel; a Single gel display depicting only the Right Gel; and a Dual Gel Display (See FIG. 11A) depicting both Left and Right gels. An Electrophoresis screen of the disclosure may display a snapshot of gel at 80% of actual gel size when in dual gel display mode. An Electrophoresis screen may display a snapshot of gel at 100% of actual gel size when in single gel display mode. An Electrophoresis Screen updates a snapshot of a gel approximately every 10 seconds plus the Method exposure time when in single gel display mode. An Electrophoresis Screen updates a snapshot of each gel approximately every 20 seconds plus the Method exposure time when in dual gel display mode. An Electrophoresis Screen has a Pause button to allow a user to pause an experiment. An Electrophoresis Screen allows a user to save the last snapshot taken of gel when in paused mode. An Electrophoresis screen allows a user to resume an experiment when in paused mode. An Electrophoresis Screen allows a user to end an experiment when in paused mode and an Electrophoresis Screen allows a user to end an experiment without analyzing and generating reports if so desired by the user. An Electrophoresis Screen displays the progress while analyzing and generating reports at also at the end of an electrophoresis experiment.

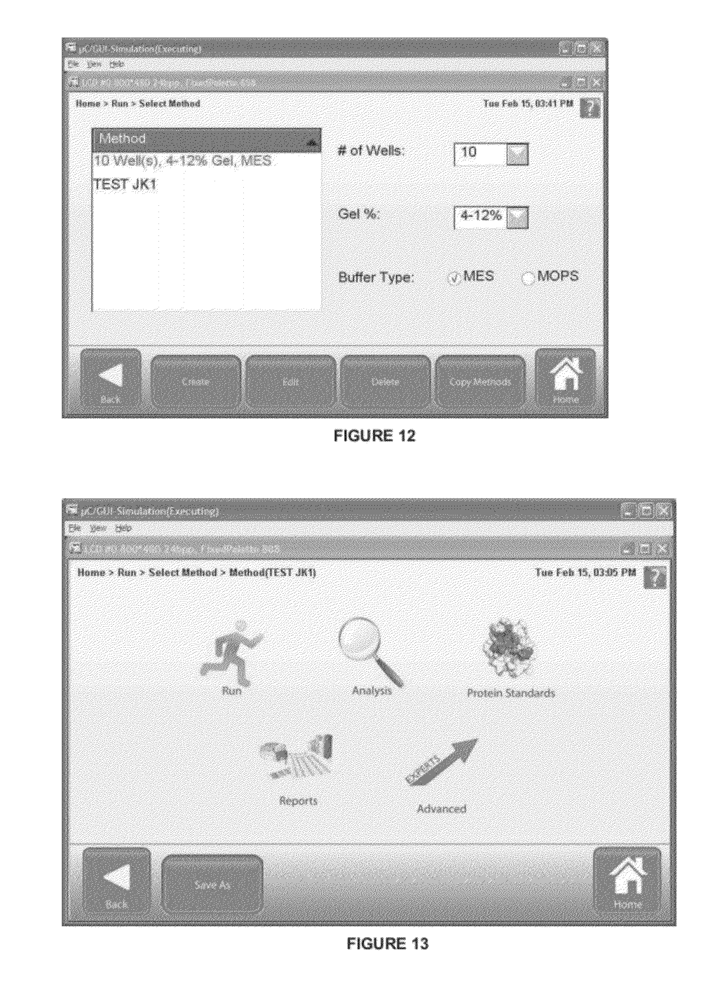

A GUI of the disclosure also comprises a Method Select Screen as shown for example in FIG. 12. A Methods screen allows a user to set method filter parameters such as but not limited to the number (#) of wells in a gel, the Gel % referring to the percentage of polymeric materials (polyacrylamide, agarose etc.) used to form a gel; the Buffer Type used. Parameters that a user may select during performing a method of the disclosure may include selecting in a Methods Select Screen for the # of Wells filter parameter the number of wells from a dropdown menu such as 8+1, 10, 12, 15 or 17. A user may further select in a Methods Select Screen for Gel % filter the percentage of a gel used from a dropdown menu such as 8%, 10%, 12% or 4-12%. A user may also select in a Method Select screen for Buffer Type filter standard buffers such as MES or MOPS. A Method Select Screen displays all and only those methods that match selected filter settings. A Method Select Screen displays read-only methods in red. A Method Select Screen also allows a user to create a new method using the Create button and entering in the screen that appears different combinations of parameters and/or filters as desired. A user may use the Copy Method button to copy a method and edit the method as desired. A Method Select Screen allows a user the ability to sort methods by name. User-created methods by default may have the settings of 10 Wells, 4-12% Gel, MES method, which may be modified as desired by a user.

Method Screens allow users to edit or delete user-created method using the Edit and Delete buttons. However, Method Screens do not allow users to delete or overwrite read-only methods. Method screens allow users to edit read-only method and to save as user-created or user edited methods. Method Screen require users to give a unique name to a user create a new method that is created by a user.

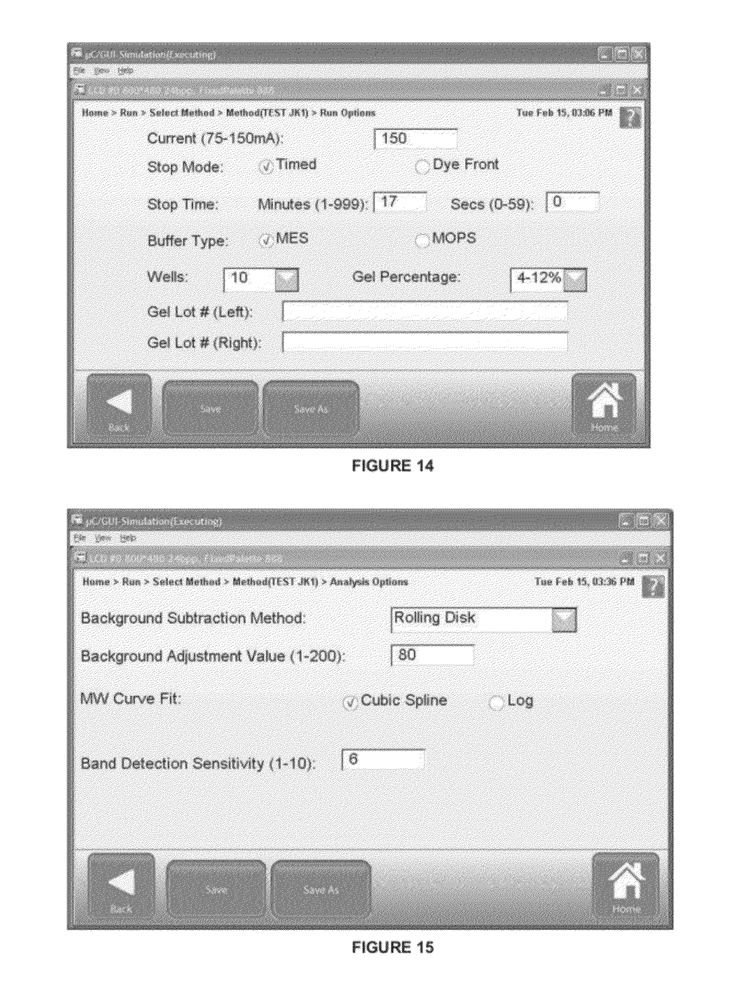

A Method Menu Screen is shown in FIG. 13 which allows a method to be Run, or allows the analysis utility to be launched by pressing the Analysis button, allows selection of standards for an experiment by pressing on the Protein Standards button, allows the generation of reports by clicking on the Reports button and also allows advanced functions by clicking Advanced button. Clicking each of these buttons generates additional screens as described in FIG. 14-FIG. 18.

FIG. 14 shows a Methods Run Option Screen which allows a user to add and edit various parameters relater to running a gel. FIG. 15 shows a Methods Analysis Option Screen which allows a user to select or enter various parameters relater to gel analysis including selecting a method for background subtraction, selecting a value for background adjustment, selecting a molecular weight curve fit and selecting the sensitivity of detection of a band on a gel. Both screens of FIG. 14 and FIG. 15 have Back, Save, Save As and Home buttons.

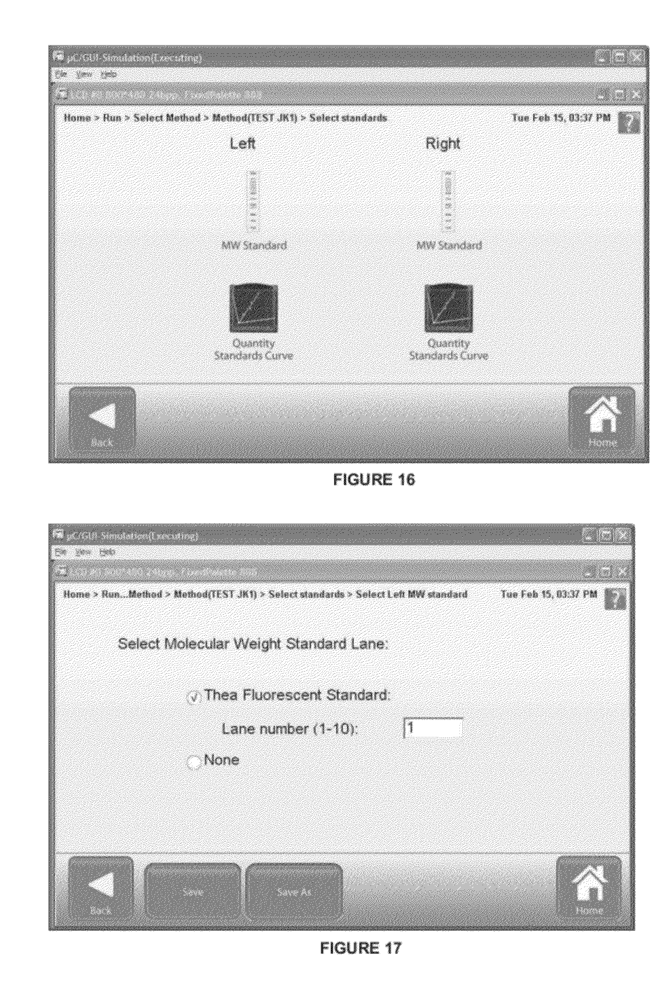

FIG. 16 shows a Methods Protein Standards Screen which allows a user to select left and right molecular weight standards and select a quantity standards curve for each standard lane. FIG. 16 also has Back and Home buttons.

FIG. 17 shows the Methods Molecular Weight Standard Screen which allows a user to select a lane number for a particular molecular weight standard. A Method MW Standard Screen is operable to gray out a lane number entry when None is selected. A Method MW Standard Screen also shows the allowable range for Lane number according to a comb type selected (i.e., # of Wells selected in a Method screen).

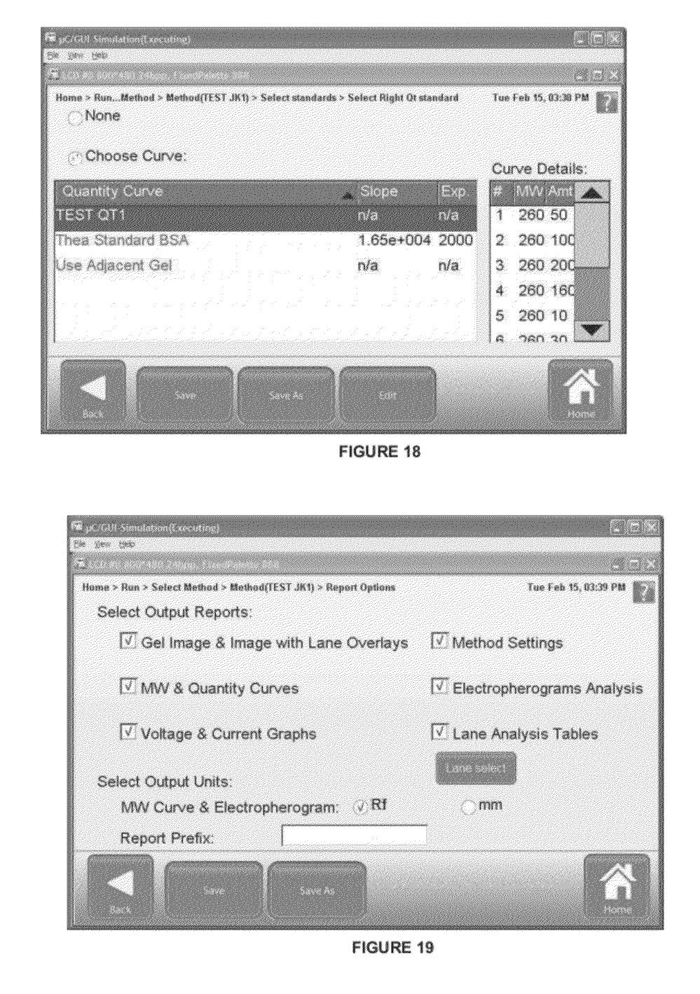

FIG. 18 depicts an exemplary Method Quantity Standards Curve screen which allows a user to choose a curve. The screen disables the quantity curve table if the option None is selected. A Method Quantity Standards Curve screen allows a user to sort the quantity curve table by a Quantity Curve name. A Method Quantity Standards Curve screen allows a user to view Curve Details for a user-created quantity standard. The slope for a user-created quantity standard curve can calculated by the software and is available after completion of gel run. FIG. 18 also has Back, Save, Save As, Edit and Home buttons.

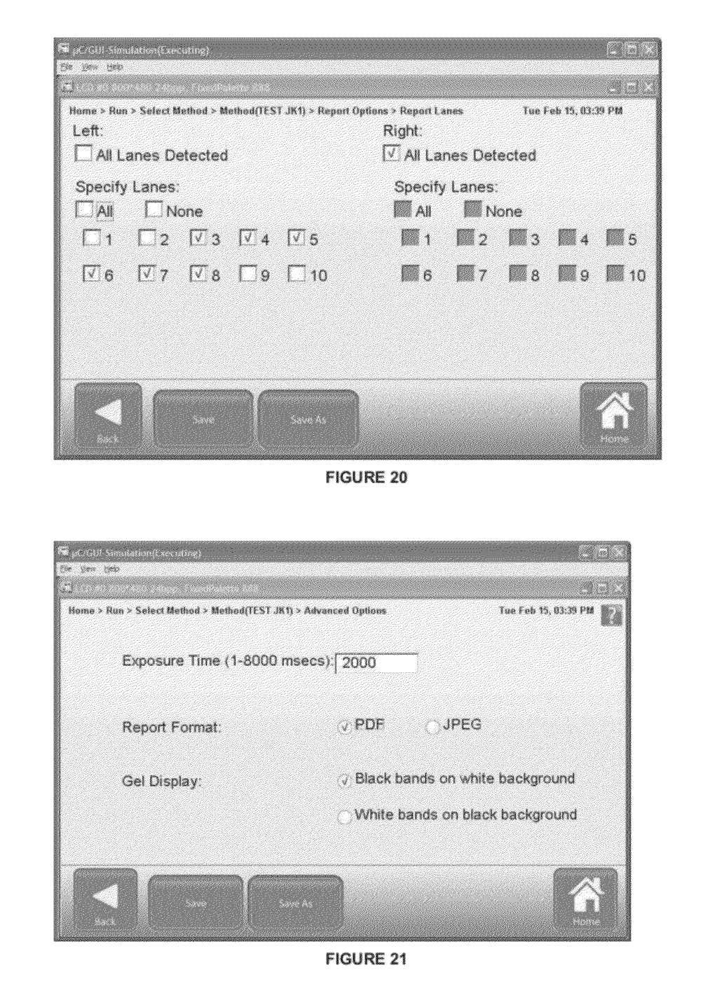

FIG. 19 depicts an example of a Method Report Options Screen, which allows a user to select a variety of options for generating reports. Report outputs may be in a PDF/JPEG format and the contents of an output can be dictated by settings in Report Options. A Method Report Options screen allows a user to select lanes for electropherogram analysis to be included in a report. FIG. 19 has Back, Save, Save As and Home buttons. Clicking the Lane Select option button takes a user to a Method Report Lane select Screen shown in FIG. 20.

FIG. 20 depicts an example of a Method Report Lane Select Screen, which allows a user to select lanes for options for generating reports. Method Report Lane Select screen allows a user to enable an auto sample detect feature. Method Report Lane Select screen allows a user to disable auto sample detect and specify lanes for which band detection and analysis is desired to be performed. FIG. 20 also has Back, Save, Save As and Home buttons.

FIG. 21 depicts an example of a Method Advanced Options Screen, which allows a user to select exposure time and formats for generating reports. FIG. 21 also has Back, Save, Save As and Home buttons.

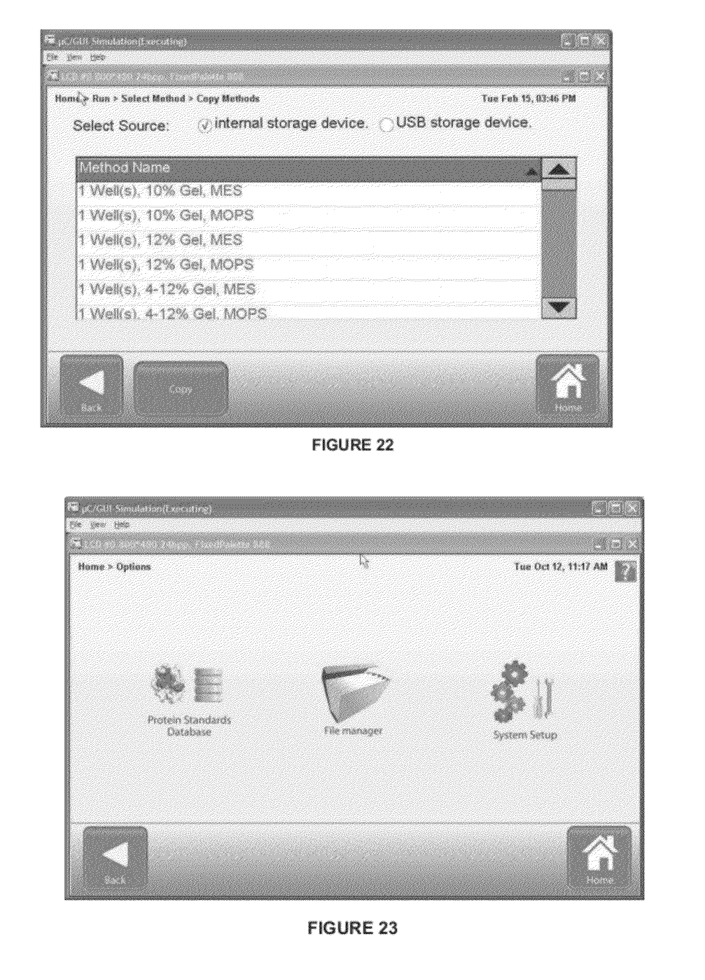

FIG. 22 depicts an example of a Method Copy Screen, which allows a user to select where a user would like to save a method and provides options of internal storage devices on the computer system 10 or external USB storage devices. Accordingly, in some embodiments, Method Copy screen allows a user to copy method files from a gel electrophoresis or gel processing instrument or device or system to a USB storage device. For example, a Method Copy screen allows a user to copy to methods from a gel processing device, system and/or instrument (named Thea in FIG. 22) to method files placed in the root directory of USB storage device. A Method Copy screen also allows a user to select multiple methods to transfer between the instrument and USB storage device. A Method Copy screen also allows a user to sort methods by name. FIG. 22 also has Back, Copy and Home buttons.

GUI screens may also have a Reanalyze Button that takes a user to a Reanalyze Screen (not expressly depicted) that allows a user to reanalyze data by changing any parameter as described.

A GUI of the disclosure may also comprise an Image Button that takes a user to a an Image Screen (not expressly depicted) that allows a user to change one or more image options.

A GUI screen of the disclosure may also have an Options Button that takes a user to an Options Screen shown in FIG. 23 that allows a user to option screens such as a Protein Standards Database screen, a File Manager screen or a System Setup screen as described above. Breadcrumbs for Options screen may read “Home>Options.”

Clicking on the System Setup button allows a user to access following screens: Time and Date screen; FTP Setup screen; Calibration screen; and Service screen. Breadcrumbs for System Setup screen shall read “Home>Options>System Setup.”

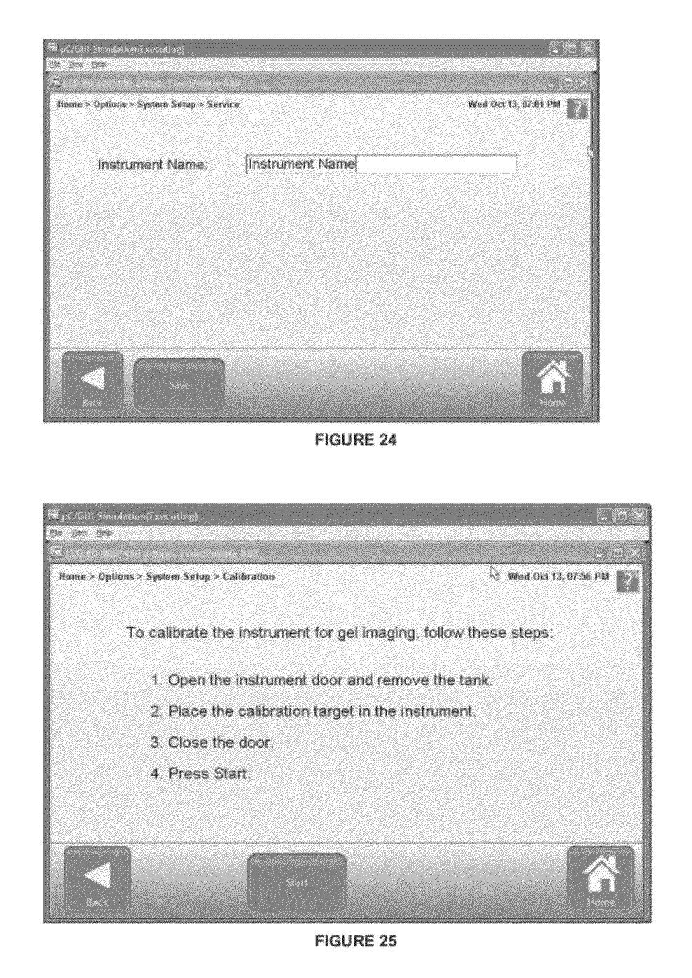

An example Service screen GUI is shown in FIG. 24 and may be used to change Instrument Name. In some embodiments, an Instrument Name field may be alpha-numeric and up to 400 pixels in length. Default for Instrument Name field is “Instrument Name.”

An example Calibration screen is shown in FIG. 25 and allows a user to calibrate an instrument for gel imaging.

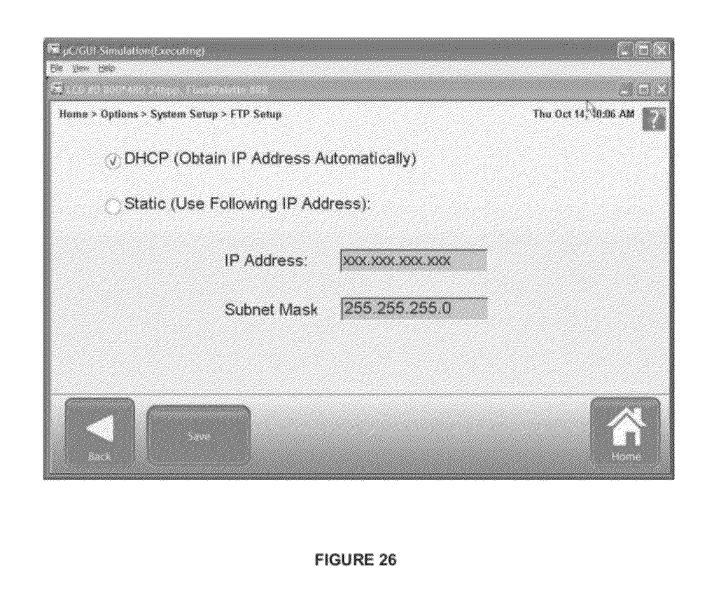

An example FTP Setup screen is shown in FIG. 26 and allows a user to select one of following IP settings for FTP server: DHCP or Static IP. When DHCP is selected in FTP Setup, the software obtains an IP address automatically from a DHCP server on the network the instrument is connected to. When Static IP is selected in FTP Setup, the software allows a user to set following fields: IP Address; Subnet Mask; and Default Gateway (not shown in the screen)

Software 11 of computer system 10 also comprises Functional Specifications (which are non-GUI specifications). These may be performed automatically by computer system 10. In some embodiments, a functional specification of software 11 may turn on and off the LEDs following door opening of the instrument. Accordingly, software 11 may turn on the LOAD LEDs (i.e. blue LEDs at 10% of their full intensity) whenever the instrument (gel electrophoresis device/system) door is open. In some embodiments, software 11 may turn off the LOAD LEDs when the instrument door is closed or open for longer than or equal to 2 minutes.

Functional specifications of software 11 also automatically run a check prior to starting an experiment to review if the system 100 is ready for an experiment. A run check workflow may occur at various stages during an experiment. In some embodiments, a run check workflow may comprise software 11 checking the available memory of an internal storage device and software 11 warns and prevents a user from running an experiment when the internal storage device has less than or equal to 28 MB of memory available. In some embodiments, a run check workflow may comprise software 11 checking the available memory of an internal storage device and software 11 warns and prevents a user from running an experiment when the internal storage device has less than or equal to 112 MB of memory available.

In some embodiments, a run check workflow may comprise software 11 checking if molecular weight standards have been set and selected. Software 11 warns and prevents a user from running an experiment in a dye-front mode when no MW standard has been set in the user selected Method. Software 11 warns and prevents a user from running an experiment when a Quantity standard is set but no MW standard is set in a user selected Method. Software may also warn and prevent a user from running an experiment when a MW standard lane does not match the well type set in the user selected Method.

In some embodiments, software 11 may warn and prevent a user from running an experiment when Use Adjacent Gel is selected for a Quantity curve in a user selected Method but no Quantity curve is set or no load is detected in the adjacent gel.

In some embodiments, software 11 runs a check and warns a user when no MW standard is set in a user selected Method.

In some embodiments, a run check workflow may comprise software 11 checking to see if the door of the instrument/system is closed prior to beginning a gel run and/or imaging and/or analysis and software 11 may warn and prevent a user from running an experiment when a door is detected to be open.

In some embodiments, a run check workflow may comprise software 11 checking the communications systems of system 100 and sending a warning and preventing a user from running an experiment when the communications are disrupted or non-functional. For example, software 11 may warn and prevent a user from running an experiment when communications to a low level controller board are non-functional; and/or when communication to a camera board in the image capture system is non-functional.

In some embodiments, a run check workflow may comprise software 11 checking the current and voltage at which electrophoresis is being performed and warning and preventing a user from running an experiment when the resistance of each gel detected does not fall between a pre-set resistance range, such as for example between 1.0 kOhm and 1.4 kOhm.

In some embodiments, a run check workflow may comprise software 11 checking each well of a gel and warning and preventing a user from running an experiment when one or more well(s) on each gel cannot be located.

Functional Specifications of software 11 may, in some embodiments, automatically create for each gel processing certain folders in an internal storage device. In some embodiments, software 11 may create, for each gel run, folders such as, but not limited to, experiment folder in a space on an internal storage device (e.g., named as /Data). An experimental folder may be named using a formula such as “Method Prefix” (if entered)+“Time Stamp” (in MM DD YYYY HHMM)+“Side” (L or R). In some embodiments, software 11 may store one or more gel images taken during a gel run in a folder created for the experiment. A folder with a gel image may be named automatically using the following formula: “experiment folder name”+“-”+“index” where index starts from 1 and increments by 1.

In some embodiments, software 11 may save gel image in 16-bit grayscale TIFF format. Typically software 11 may save the last gel image taken when an experiment is ended by user. Software and hardware functions of the computer system 10 integrate with components of gel electrophoresis system 12 while performing electrophoresis.

Software and hardware of the system may comprise several features. In some embodiments, a combination of one or more of the following user input options may be supplied: initiate run, defined, allowed, enabled, controlled via method files, illumination, abort run, end run, image and analyze, and select report attributes. In some embodiments, the software may have one or more of the following attributes, for example, automation of electrophoresis runs from insertion of the gels through analysis report generation. In some embodiments, multiple types and lanes of MW/concentration standards may be used on the same gel during the same run. In some embodiments, automatic identification and creation of run lanes may be provided based on information about the gel being inserted. In some embodiments, storage of lane templates (either pre-stored or user inputted) may be provided for various gel types/well configurations. In some embodiments, pre-stored information about various existing protein standards, storage of user-input information about protein standards, and MW data editable for protein standards, are provided. In some embodiments, automatic real time detection of bands is provided. In some embodiments, fluorescence calibration generation of a MW vs Rf chart is provided, for example, including calibration and curve fitting, determination of MW based on a standards calibration, determination of purity (band percentage), relative protein quantitation, and absolute protein quantitation. In some embodiments, the features and adjustable parameters that may be provided may include, but are not limited to, generate “real-time” minimum 16-bit color images, save image as TIFF, JPEG, or bitmap, embed gel image (at least 300 dpi resolution) into output, image editing including but not limited to adjustment of brightness, zoom, crop, and the like and provision of annotations, lane boundary editing, lane tilt/warp correction capability, manual band detection, manually select area of interest (gel region, single lane, band), band-detection sensitivity adjustment capability, band editing capability, accommodate different exposure times, and fluorescence/absorbance band detection duality. In some embodiments, the features and adjustable parameters that may be provided may include, but are not limited to, generate and display real-time electropherogram image of the detected bands for each lane including background subtraction, including information such as a display of the lane image with the electropherogram, peak ID/band number in each lane, peak position (pixel, mm, Rf), peak height, peak area and peak volume, peak width & resolution based on band sharpness, peak splitting with Gaussian peak fitting capability, peak normalization (band-to-band, lane-to-lane), electropherogram subtraction, electropherogram overlays on screen, band pattern matching (across gels), comparative accuracy, and reproducibility (MW). In some embodiments, comparative reproducibility (purity), Inter-gel analysis—MW, concentration, mass, and purity, and inter-gel normalization may be provided. In some embodiments, a gel performance/quality confirmation and/or a final background subtracted electropherogram image may be provided. In some embodiments, two-way communication between an NGE instrument and a PC may be provided. In some embodiments, data transfer from an instrument to an external source at the end of a run may be provided. In some embodiments, the features and adjustable parameters that may be provided may include, but are not limited to, read and record gel type (Cat #, lot # and unique identifier) such as from a barcode or from a gel image, touch-screen GUI, software updating capability and functions, data table generation (for example, EXCEL formatted), generate and print report format/layout (for example, MS WORD), Link to other files (import/export functions), Print, high resolution image (at least 300 dpi), operating System compatibility (for example, with WINDOWS), exportable (for example, to EXCEL) table files, pre-loaded printer drivers, print capability without a PC, and macro writing capability.

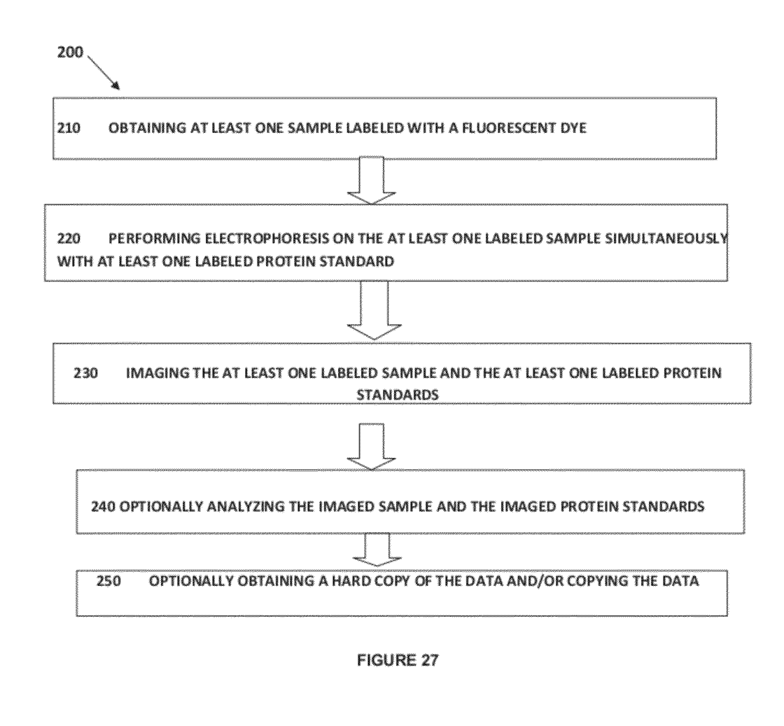

Accordingly, the present disclosure also describes methods for performing gel processing. Method of gel processing of the disclosure, in some embodiments, comprises performing gel electrophoresis. Workflow of methods for gel electrophoresis according to some embodiments of the disclosure may comprise a limited processing step that encompasses introduction of one or more samples to an electrophoresis gel and may end in some embodiments with the generation of a results report. An example method 200 of the disclosure is depicted in FIG. 27 and may comprise using gel processing system 100 and may begin at step 210 comprising obtaining at least one sample labeled with a fluorescent dye, proceeding to step 220 comprising loading the at least one labeled samples on an electrophoresis gel and performing electrophoresis on the at least one labeled sample. Step 220 may, in some embodiments, further comprise loading and electrophoresing at least one labeled protein standard simultaneously with a labeled sample. In some embodiments, at least two labeled protein standards may be used and may be labeled with the same fluorescent dye as used to label the sample. In some embodiments, the method may comprise step 230 comprise imaging the at least one labeled sample and imaging the at least one or at least two labeled protein standards. The performing and the imaging steps may be operably associated with each other and may be automated. The performing and the imaging steps may be operably associated with each other and may be performed in a system of the disclosure (e.g., system 100). In some embodiments, a method may optionally further comprise step 240 comprising analyzing the imaged sample and the imaged protein standards. Step 240 may comprise one or more of the following analysis steps such as, but not limited to, determining the molecular weight of the labeled sample, determining the relative amount of at least one labeled protein in the sample, and/or determining the absolute amount of at least one labeled protein in the sample. In some embodiments, the analysis step 240 may comprise plotting the molecular weight data of the protein standards in a curve and plotting the data of at least one labeled protein from the sample onto the curve to determine the molecular weight. In some embodiments, method 200 may optionally further comprise step 250 comprising copying and/or obtaining a hard copy of the analyzed image, for example, a printout or copying to a USB stick.

The present disclosure describes methods of gel processing comprising the use of software components 11 of computer system 10. In some embodiments, methods of the disclosure may comprise one or more steps that may be run automatically by the software in response to actions like switching on the instrument and/or starting an experimental flow. In some embodiments, methods of the disclosure may comprise steps that are controlled by user entered parameters.

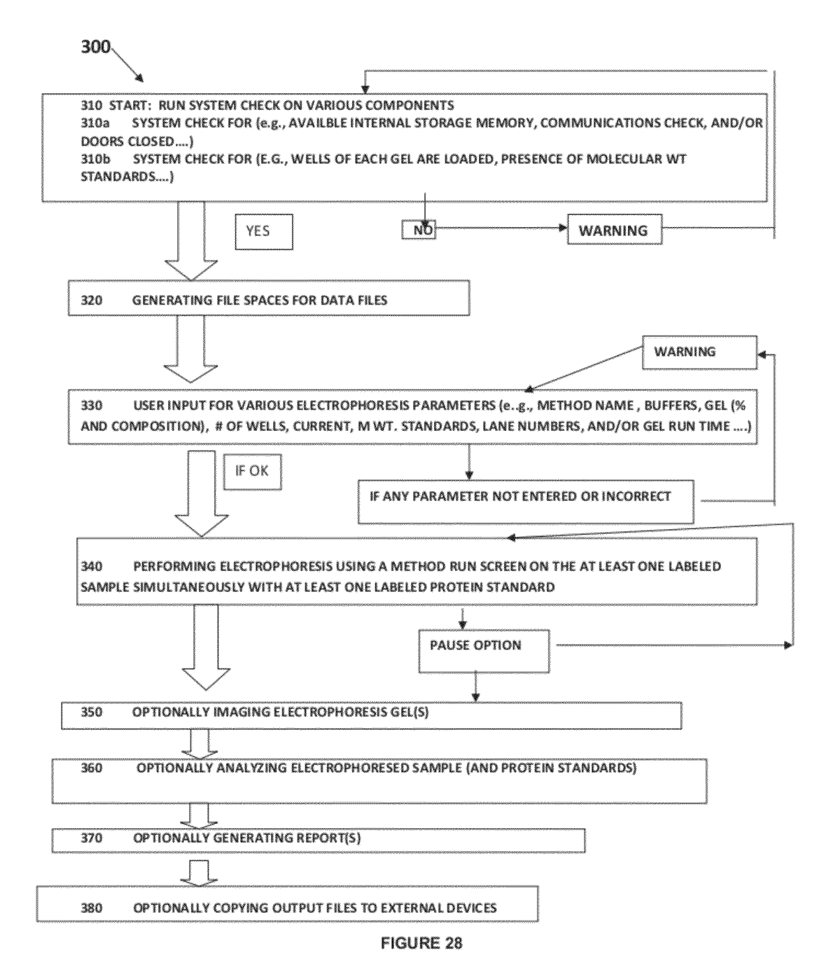

FIG. 28 depicts an example embodiment of a method of the disclosure performed on a gel processing system of the disclosure (such as system 100) comprising the use of software components 11 of computer system 10 comprising a computer readable medium comprising computer readable instructions, which, when executed by the computer system, are configured to display on a display. For illustration purposes while describing method 300 shown in FIG. 28, reference is made to system components described in FIG. 1. Method 300 begins at step 310, (which may start following switching on of system 100 and/or by pressing a Start button on a display GUI screen), wherein computer system 10 runs a system check to checking the functionality of the system for performing a gel processing method. Step 310 may comprise checking one or more features and/or components of system that may be checked by a pre-programmed software function. Described are some example embodiments that may be checked on step 310. One of skill in the art, in light of this disclosure, may recognize that step 310 may comprise checking one of these embodiments, all these embodiments, and/or various combinations of these embodiments as well as additional system level checks not expressly mentioned.

In one example embodiment, step 310 may comprise step 310a comprising using a software function to check the available memory of an internal storage device. If the memory of the internal storage device is found to be sufficient, by comparing the available memory to a pre-set range of what is an acceptable range of internal storage memory, the method proceeds to step 320. If insufficient memory is found in the internal storage device a software function generates a warning message to the user and returns to the beginning of step 310 thereby preventing the method from proceeding further.

In some embodiments, step 310a may comprise another internal component check comprising using a software function to check checking communications systems of system 100 and sending a warning and preventing a user from running an experiment if communications are disrupted or non-functional. In some embodiments, step 310a may comprise checking one or more of the following communication systems and communication interfaces: communication to and from cameras of the system are checked; communication to and from the LCD is checked; communication links to and from the processor to various components are checked; and/or communication links to the imager are checked.

In some embodiments, step 310a may comprise system checks, such as for example, but not limited to, checking to see of if device/system doors are closed prior to start an electrophoresis.

Step 310 may also comprise step 310b using software functions to check the system for parameters and components which are involved with the gel electrophoresis procedure, such as, gels related features such as, but not limited to, number of wells, loading of samples in each well, loading of molecular weight standards in some wells, buffer levels. Accordingly, in some embodiments, step 310b may comprise running a system check if the sample wells of each gel loaded can be located; if protein molecular weight standards are present; if quantity standards are present; and/or if the resistance of each gel loaded falls between 1.0 k Ohm and 1.4 k Ohm.

In one embodiment, a Start Screen GUI may be used by a user to initiate step 310 system checks prior to starting a gel processing experiment and to visually monitor the progress of each system checks performed prior to starting a method of the disclosure on a sample. The Start Screen informs a user by moving to the next screen if all system checks pass and if one or more system checks fail a Warning message issues on the screen informing a user the particulars of a system check test that failed. If step 310 fails the method loops back to the beginning of start at step 310. The system check step 310 may repeat till all system set up checks are passed.

Once step 310 comprising system checks are completed successfully, the method proceeds to step 320 where automated software functions generate a file space in the internal data storage to store data that will be generated during the method. Files may be automatically named using pre-defined formats for ease of location and tracking. Users may have the options to rename files if desired.

The method may then proceed to step 330 comprising obtaining user input or selections for electrophoresis and selecting and/or creating method files comprising computer readable instructions and comprising user input/selection. In step 330, wherein user input or user selections are requested by software functions by means of a GUI interface to supply one or more parameters, such as, but not limited to, name for the current gel processing method (e.g. method file name), type of buffers used to run a gel, type of gel (percentage and composition of polymeric material used), type of dye/fluorescent marker, number of wells that will be loaded, voltage, current, time, maximum current limit, and combinations thereof at which a gel is run, molecular weight standards to be used, lane numbers in which molecular weight standards are placed, a load volume of a standard, a load volume of a sample, a pre-set gel run time and/or an auto stop mode, for example, comprising run time in minutes, or dye front tracking. A user may also input/select if each gel may independently use its own standard or it may use the standard from a different gel. For instance, in a two running reservoir run, the right gel may select Lane 1 of the left gel to use as a standard for calculation. In some embodiments, user input of one or more of these parameters may open one or multiple GUI screens (such as one or more of those described in FIGS. 7-14, 16-18, 22 and 23-25) for entry of additional related parameters or details.

In some embodiments, the parameters selected or inputted by a user results in the creation or selection of one or more method files. Method files may generally be repositories of parameters controlling a gel electrophoresis device, imaging device, and analysis and report generation devices. Method files may be available for user definition. They may consist of user editable fields and a set of default values. Method files comprising computer readable instructions may be read by computer control system 10 to set the conditions for running electrophoresis in gel electrophoresis system 12. Method files comprising computer readable instructions executed by computer control system 10 to run an electrophoresis i.e., perform electrophoresis in gel electrophoresis system 12.

Accordingly, in one embodiment, step 330 may comprise generating at least one method file comprising computer readable instructions and having a plurality of electrophoresis parameters, wherein the one or more electrophoresis parameters may be either selected from default values, and/or entered manually by a user, and/or certain values may be selected and certain values may be manually added by a user.

In some embodiments, the same or different method files may also be generated in step 330 for imaging step (350), analysis step (360), report generation step (370) which are discussed below. In some embodiments, method files for imaging step (350), analysis step (360), report generation step (370) which are discussed below may be generated in those steps as well. In some embodiments, method 300 may comprise generating at least one method file comprising computer readable instructions and having a plurality of imaging parameters, wherein the one or more imaging parameters may be either selected from default values, and/or entered manually by a user, and/or certain values may be selected and certain values may be manually added by a user. In some embodiments, method 300 may comprise generating at least one method file comprising computer readable instructions and having a plurality of analysis parameters, wherein the one or more analysis parameters may be either selected from default values, and/or entered manually by a user, and/or certain values may be selected and certain values may be manually added by a user. In some embodiments, method 300 may comprise generating at least one method file comprising computer readable instructions and having a plurality of reporting parameters, wherein the one or more reporting parameters may be either selected from default values, and/or entered manually by a user, and/or certain values may be selected and certain values may be manually added by a user.

In some embodiments, at least 30 method files may be available. One method file may be used for each run of an electrophoresis device/system or separate method files may control the runs in separate running reservoirs. Run specific parameters, including voltage, current, stop mode, running buffer, and the like, may be separate from gel specific parameters (standards, lanes, and the like) within a method file.

If any parameters are incorrectly entered, not entered or have values exceeding the allowed range for an instrument a Warning message issues on the screen informing a user that certain parameters are incorrect or need to be changed. If a Warning message is issued in step 330 the method loops back to the beginning of start at step 330. Step 310 may repeat till parameters are entered. If all parameters are entered and correct an Electrophoresis screen with the option to Run the electrophoresis appears.

Method 300 may then proceed to step 340 where the system 100 performs electrophoresis on one or more gels loaded with one or more samples and one or more molecular weight standard markers based on the criteria of the method files generated in step 330. In some embodiments, step 340 may comprise, following a successful completion of step 330, a user pressing a method Run button on a GUI screen. Electrophoresis is performed in accordance to user selected and/or input options that are stored in one or more computer readable method files. Progress of electrophoresis may be monitored during step 340 by means to a GUI screen such as Electrophoresis Screen described in FIGS. 11A and 11B where gels may be viewed as a single gel, or a dual gel. An Electrophoresis Screen typically updates itself periodically so that a user may view progress of the electrophoresis at pre-chosen periodic intervals. In some embodiments, a “real-time” image may be generated on the Electrophoresis Screen. For example, a display of “real-time” images of gels during electrophoresis may be provided. One or multiple gel images may be simultaneously displayed side by side on the display. The lane overlay may be displayed horizontally across the top of each gel image, and Rf tracking marks may be displayed vertically along the sides of the gel. The Rf marks may dynamically update, with Rf 1.0 tracking the dye front. Gel images may be presented with black bands on white background or configurable as white bands on a black background. Image display modes may include: a) two gels simultaneous ˜80% scale, b) or a single gel at 100% scale. User may select and toggle on thumbnail images for various imaging display modes; thumbnail may highlight what is being shown. The gel image display may be updated as fast as possible, but no more frequently than the image capture rate. A pause option by pressing a Pause button during the run may be used to allow the user to examine the gel image before the run is complete. Initiation of the pause option turns off the power supply to the gel and then allows the user to have the option to collect any relevant data (such as by photographing the gel, and/or proceeding to step 350 comprising imaging the gel, further proceeding to steps 360 comprising analyzing the gel), and/or resume the run, and/or terminate the run and/or collect any relevant data.

In some embodiments, step 340 may comprise automatically stopping the electrophoresis following completion of the run for example if tracking of a dye front with feedback to the run controller to auto stop once the front has advanced as far as desired.

Method 300 may, in some embodiments, further comprise imaging a gel in step 350. As described in step 340, some embodiments may comprise imaging 350 during simultaneously performing 340 (while paused and/or while running). Imaging may comprise running a calibration check calibrate a gel for imaging.

Step 350 of imaging may comprise exposing the labeled sample to at least one light source. In some embodiments, the imaging may comprise exposing the labeled sample to at least one blue light source. In some embodiments, the at least one blue light source may comprise an LED blue light source. In some embodiments, the at least one light source emits light in a wavelength range of from about 400 nm to about 800 nm, such as for example ˜475 nm which corresponds to blue light. In some embodiments, the at least one light source emits blue light in a wavelength range of from about 520 nm to about 640 nm.

In some embodiments, step 350 may comprise obtaining user based input and or selection of one or more imaging parameters, such as, but not limited to, exposure time, type of fluorescence to be measured. These inputs may be entered and/or modified in step 330 or prior to starting step 350. Images obtained may be date and time stamped and may be associated with the gel and the method from which it was derived. Images may be stored in a space on the internal storage memory for data files.

Step 350 may also optionally include a variety of steps to refine the image obtained such as, but not limited to, background noise subtraction, defining gel lanes, improving band detection, sensitivity of band detection. These functions and capabilities may be carried out by the software and other computer system related functionalities. In some embodiments, components of system 100 such as gel electrophoresis device 20 and/or software 11 or other components of computer system 10 may provide background subtraction after image acquisition. A background image of one or more gels may be captured prior to the start of imaging and this image may be used for background subtraction. A display electropherogram showing background subtraction may be provided. An electropherogram image used for background subtraction purposes may display peak histogram, gel/lane number, background line, and associated gel/lane slice image. The scale of an electropherogram may match the lane image scale and the bands may align with the peaks. Background subtraction may be conducted using a rolling disc method before band detection. The user may adjust the radius for a rolling disc method from 100 to 900 in 100 increments using a rolling value index and up/down arrows. An electropherogram may be displayed for live display of rolling disc adjustment effect after each run. Rolling disc values may be saved in the method file associated with a particular gel. Default rolling disc radius may be set and may be user adjustable. The rolling disc radius may be annotated on electropherogram images and reports, for example, as background subtraction: rolling disc, radius=X. Other suitable background subtraction methods may be supported. For example, FIG. 15 shows a GUI screen with options for background subtraction methods that may be selected by a user from a drop down menu. A user may view on a display screen user-selected units from a method file. Peak numbers, widths, pixel intensity and other annotations may be shown. The electropherogram image used for background subtraction adjustment may be from the lane with the most band/peaks as determined with a specific default rolling disc radius, for example, of 800. In some cases, a user may select any other lane from a particular gel to make an adjustment.

In some embodiments, imaging may comprise automatic lane creation. Software functions may automatically create lanes after acquisition of a gel image. Bar code or printed information from a cassette image may be used to establish lane boundaries, for example Rf=0 may be set by a user or may be identified from a barcode or printed information. Gaps between gels may be identified and prevented from being defined as a lane. Lane numbering may be restarted for each additional gel. Tilt in lanes may be taken into account with the same width at top and bottom of the gel as defined, for example, by a comb, vertically aligned to centroid of bands in lane. A manual selection of an area of interest may be provided for lane creation.

In some embodiments, imaging step 350 may further comprise adjusting band detection sensitivity, for example, to provide adjustment of a band detection threshold. The determination of band detection sensitivity may be configured to iterate until band count stabilizes. Sensitivity may be fixed before gel analysis, for example, with respect to final band detection, electropherogram, Band %, MW determination, and/or quantitation.

In some embodiments, imaging step 350 may further comprise providing for automatic band detection. For example, correction may be provided for band detection errors. The errors may be directly correctable by software 11 or may be corrected offline using third party analysis software. In one embodiment, method files may be configured such that user inputed or selected adjustment of background subtraction parameters may be used to affect band detection sensitivity. In some embodiments, parameters such as MW and concentration data from standards may be incorporated. One or multiple standards may be used, for each gel, for calculations. A pre-loaded standards database may be used for lanes with standards for establishing the number and location of bands. User defined standards which are not detected correctly may result in a GUI issue warning and correction window for the user. Band numbers within lanes may be displayed in electropherograms and associated with calculations. Band numbering may begin with 1 in each lane closest to Rf=0.

In some embodiments, imaging step 350 may optionally comprise acquiring an image of a western-transferred membrane. Once acquired, an analysis may be used on the software for MW assignments. This function may include reflective visible and EPI fluorescent light imaging capabilities on the imaging device. In some embodiments, a frame may be provided to hold a membrane for imaging. The membrane image may be date and time stamped, and may be associated with the gel from which it was derived. Membrane images may be stored.

In some embodiments, method 300 may of further comprise step 360 comprising analyzing an electrophoresed sample. Step 360 may in some embodiments be performed simultaneously during the electrophoresis process (step 340) and/or after the electrophoresis step 340 is completed. Step 360 may comprise one or more analysis steps such as, but not limited to, determining the molecular weight of the labeled sample, determining the relative amount of at least one labeled protein in the sample, and/or determining the absolute amount of at least one labeled protein in the sample. In some embodiments, the analysis step 360 may comprise plotting the molecular weight data of the protein standards in a curve and plotting the data of at least one labeled protein from the sample onto the curve to determine the molecular weight.

Step 360 may comprise obtaining input from a user to customize analysis of a gel. Accordingly, a user may input or select parameters such as, but not limited to, molecular weight standards to be used, type of statistical/mathematical analysis desired for electropherogram analysis (e.g. cubic spline curve, log curve). A user may select/input MW chart parameters and data table units (Rf or mm). A user may select/input quantity curve units, for example, ng, μl or picomoles. A user may select/input a quantity calibration curve, for example, left or right gel. A user may select/input a curve fit type for an MW calibration.

In some embodiments, analyzing in step 360 may comprise using GUI and software functionality for calculating, displaying, and/or printing out one or more characteristics associated with peak position, molecular weight (MW), peak height, peak area, peak volume, and band percentage. For example, a gel may be analyzed to obtain one or more of the following: generation of peak position (Rf or mm); molecular weight (MW); peak height (pixel intensities); peak area; peak volume; band sharpness; and band percentage. These characteristics may be obtained for every peak. Calculations may be background-subtracted. A display may be provided for peak number, Rf or mm, molecular weight (MW), quantity, band sharpness, and band percentage for every peak. In some embodiments, following parameters may be determined and/or calculated and the numerical values of each band in a selected lane may be presented in table form, graphically displayed, and/or printed out. Peak position (Rf) may be a value between 0.000 and 1.000. MW may be determined using the molecular weights of one or more known gel standards Peak height may be the background-subtracted peak pixel intensity of a given band. Peak area may be calculated using the following equation (band width is also known as band sharpness): Peak Area=Band Width×Band Length. Peak volume may be calculated using the following equation: Peak Volume=Peak Area×Peak Height. Volumes may be used for band % and mass quantitation. A value for % Purity (Band % per lane) may be calculated using the following equation: % Purity=(Peak Volume of Peak number in lane/Sum of Peak Volumes for Peaks in lane)×100.

In some embodiments, imaging step 350 and analysis step 360 may generate lane images and electropherograms. An electropherogram of selected lanes may be generated, for example, including lane images and annotations of lane numbers and whether the left or right gel corresponds to the image. The electropherogram's x-axis may be Rf (default) or mm (user selected) with pixel intensity on the y-axis. Rf may range, for example, from 0.0 to 1.0, left to right, in 0.1 increments. Pixel intensities may range, for example from 0 to 255 for a 16-bit gray-scale image. Peak numbers may be shown on the electropherogram of a selected lane. Peak boundaries denoting band sharpness may also be shown on the electropherogram. The electropherogram may show a background.

In some embodiments, a gel electrophoresis device and/or software and/or computer system of the disclosure may comprise or may be linked to at least one protein standards database to allow imaging and analysis functionality. A protein standards database may comprise a repository for files used by the image analysis software and may be added to or edited by the user. These files may be specified in a run method file. Described below are some analysis methods that may be comprised in step 360.

MW vs. Rf Chart:

In some embodiments, there may be a pre-defined onboard standards database containing information about MW standards. This information may include the MW for each of multiple sequentially identified bands. This database may be added to by a user. Pre-set standards may be included, for example, saved as read-only. A user may select a standard from the database for each run. A MW “calibration” curve and chart may be generated using pre-existing MW data for standards (pre-loaded or user-defined) after a gel run. This curve and chart may be displayed on a GUI screen or LCD screen and may optionally be provided in a report generated. The chart may be annotated with the gel and lane number as well as with a date and time stamp. This information may be used to generate the standards overlay displayed at the end of the gel run. Curve fitting may be cubic spline, for example, by default. Log MW or other fitting may be selected by a user (using for example a GUI screen such as shown in FIG. 15). The user may select a MW standard from the database, and which lane the standard is in (using for example one or more GUI screens such as shown in FIG. 15-18). If no MW standard is identified, MWs cannot be computed, and a Warning prompt may notify the user.

Relative and Absolute Quantitation:

In some embodiments, a pre-defined onboard standards database may include quantities for identified bands. This database may be added to by a user, but some pre-set standards may be read-only. A user may select a standard from the database for each run to be quantitated. This may be configured by a method file. A quantitation “calibration” curve and chart may be generated using pre-existing quantity data for standards after the gel run. The standards may be pre-set or user-defined. The curve and chart may be displayed on a screen and may be available for generating a report. The chart may be annotated with the gel and lane number. Curve fitting for quantitation may be linear or may be selected from a user selected option. A user may select a quantitation standard from the database, and which lane or lanes the standard(s) is/are in. The band may be selected and related to its quantity value. If no quantitation standard is identified, quantities cannot be computed, and a device prompt may be used to notify the user. Some standards may be made such that the software may determine the band from the MW location. One or more, for example, five, fields may be used for quantitation standard. Exemplary fields may include: approximate MW as determined after run; quantity; volume loaded; lane number; and quantitation standard database file. A user may select previously run calibration curves for quantitation or the curve from one or more other gels in the same run. Storage for multiple quantity curves for each gel type may be provided. Curves may be time and date stamped, for example, with gel lot number, running buffer type, gel type, and quantitation standard database selection.

In some embodiments, method 300 may further comprise step 370 comprising generating reports of data following analysis of one or more gels. Step 370 may allow a user to customize reports of a gel by inputting or selecting parameters such as, but not limited to, selecting gel image layout patters, lane overlays, voltage current graphs, lane by lane analysis, output units for molecular weight curves and/or electropherograms. A user may use GUI screens to input and/or select report generation parameters, for example, such as shown in FIG. 19-20 for report generation.

Reports generated in step 370 may be obtained from a selection of a plurality of report formats, for example, a default minimal format, a comprehensive format, and a user definable format. For example, the generation of a raw gel image may be provided at least a 16 bit 300 dpi grayscale uncompressed TIFF file, as a separate output file. The image may comprise lower quality image may be embedded within the report.

Additional exemplary report sections available for user selection may include: electrophoresis parameters, voltage, current, power, and time (digital and/or graphical); gel image annotating which is left and right from the user perspective; gel band identification marking and lane numbering; standard displayed in red, MW assignment lines with values shown on side overlaid on a gel band identification image; MW calibration curve; calibrated volume curve for quantitation; and calibrated load.

For electropherograms, reports may show “pixel intensity,” “Rf” horizontal background subtracted histogram with band numbers shown above peaks, display background level as line, real horizontal image of lane scaled aligned with peaks, background subtraction method, band noise factor and slope (S/N used to determine peak), bar code information (number of wells, gel %, and the like), standard type and assignments, buffer type, voltage, current and run time, illumination mode, folder name (lot, serial number), and power used during the gel run.

Step 370 may also comprise printing a report. In some embodiments, method 300 may also comprise step 380 where a user may copy output files to an external storage device. In some embodiments, step 380 may be mediated by file transfer between a gel processing system (such as 100) and a personal computer (PC) or other external storage device may be accomplished in any of a variety of ways, for example, via USB memory stick, via USB cable directly connected to the PC, or via Ethernet network transfer using FTP.

In some embodiments, electrophoresis methods of the disclosure, starting for example at step 310 and ending at step 370, may be performed rapidly in less than about 30 minutes. In some embodiments, a method may be performed in less than about 20 minutes. In some embodiments, a method is performed in less than about 15 minutes. Automation and software greatly increase the speed of the present methods.

In some embodiments, method 300 may also comprise a processing step at the beginning, comprising introducing one or more samples on an electrophoresis gel. In such an embodiment, method 300, beginning at processing step and ending at step 370 with the generation of a report may be accomplished in less than 60 minutes, less than 55 minutes, less than 50 minutes, or less than 45 minutes.

The workflow described in FIG. 28 may be modified according to one or more embodiments described in this disclosure. In some embodiments, a method of performing gel electrophoresis of the disclosure may comprise performing electrophoresis on at least one labeled sample in a gel processing system comprising a gel electrophoresis system; and a computer system comprising software components, the software components comprising a plurality of graphical user interface specifications and a plurality of functional specifications, wherein the gel electrophoresis system and the computer system are operably associated with each other, the method comprising: running a system check on the computer system components; running a system check on the gel electrophoresis components and on an at least one gel loaded with the at least one labeled sample in the gel electrophoresis system; generating file spaces for storing one or more files relating to the electrophoresis in the computer system; generating at least one method file comprising a plurality of electrophoresis parameters in the computer system; and performing electrophoresis using the at least one method file generated using a run functional specification of the graphical user interface specifications to obtain at least one electrophoresed sample. The method may further comprise performing electrophoresis on at least one labeled protein standard simultaneously with the at least one labeled sample.

In some embodiments, a method of performing gel electrophoresis of the disclosure may comprise performing electrophoresis on at least one labeled sample in a gel processing system comprising: a gel electrophoresis system; and a computer system comprising a computer readable medium comprising computer readable instructions, which, when executed by the computer system, are configured to display on a display, wherein the gel electrophoresis system and the computer system are operably associated with each other; the method comprising: running a system check on the computer system components; running a system check on the gel electrophoresis system components and on an at least one gel loaded with the at least one labeled sample in the gel electrophoresis system; generating at least one method file comprising computer readable instructions and having a plurality of electrophoresis parameters in the computer system; and performing electrophoresis comprising executing the at least one method file comprising computer readable instructions by the computer system to obtain at least one electrophoresed sample. The method may further comprise performing electrophoresis on at least one labeled protein standard simultaneously with the at least one labeled sample.

In some embodiments, the method above may further comprise imaging the at least one labeled sample with an image capture system to obtain an imaged sample, wherein the performing electrophoresis step and the imaging step are operably associated with each other and the imaging is executed at least in-part by the computer system.

In some embodiments, the method above may further comprise analyzing the imaged sample with an image analysis system operably associated with the image capture system, wherein the analyzing is executed at least in-part by the computer system.

In some embodiments, the method above may further comprise generating reports of the analyzed image sample, wherein the generating reports is executed at least in-part by the computer system.

In some embodiments, analyzing the electrophoresed sample may comprise determining the molecular weight of the at least one labeled sample. In some embodiments, this may comprise plotting molecular weight of the labeled protein standards in a curve and plotting the data of at least one labeled protein from the at least one labeled sample onto the curve to determine the molecular weight of the at least one labeled protein.

In some embodiments, analyzing the electrophoresed sample may comprise determining the relative amount of at least one labeled protein comprised in the at least one labeled sample. In some embodiments, analyzing the electrophoresed sample may comprise determining an absolute amount of the at least one labeled protein in the sample.

In some embodiments, a method of performing electrophoresis of the disclosure may comprise performing electrophoresis on at least one labeled sample in a gel processing system comprising: a gel electrophoresis system; and a computer system computer system comprising a computer readable medium comprising computer readable instructions, which, when executed by the computer system, are configured to display on a display, wherein the gel electrophoresis system and the computer system are operably associated with each other, the method comprising: setting up at least one gel loaded with the at least one labeled sample in the gel electrophoresis system; running a system check on the computer system components; running a system check on the gel electrophoresis components and on the at least one gel loaded with the at least one labeled sample in the gel electrophoresis system; generating at least a first set of computer readable instructions comprising a plurality of electrophoresis parameters; and performing electrophoresis comprising executing the first set of computer readable instructions by the computer system interfacing with the gel electrophoresis system to obtain at least one electrophoresed labeled sample. The method may further comprise performing electrophoresis on at least one labeled protein standard simultaneously with the at least one labeled sample.

The method may further comprise generating at least a second set of computer readable instructions having a plurality of imaging parameters. The method may further comprise comprising imaging the at least one electrophoresed labeled sample with an image capture system to obtain an imaged sample, comprising executing the at least second set of computer readable instructions by the computer system interfacing with the image capture system.

The method may further comprise generating at least a third set of computer readable instructions having a plurality of analysis parameters. The method may further comprise analyzing the imaged sample with an image analysis system operably associated with the image capture system, comprising executing the third set of computer readable instructions by the computer system interfacing with the image analysis system.

The method may further comprise generating at least a fourth set of computer readable instructions having a plurality of report generation parameters. The method may further comprise generating reports of the analyzed image sample, comprising executing the at least fourth set of computer readable instructions by the computer system interfacing with electrophoresis system.

The method may further comprise generating file spaces for storing one or more data files relating to the electrophoresis in the computer system.

Methods of the disclosure may in some embodiments further comprise, performing electrophoresis on at least one labeled protein standard simultaneously with the at least one labeled sample. Methods of the disclosure may in some embodiments further comprise, performing electrophoresis on a plurality of labeled samples. Methods of the disclosure may in some embodiments comprise performing electrophoresis on labeled samples comprising proteins.

Methods of the disclosure as described above may in some embodiments further comprise, imaging the at least one labeled sample with an image capture system to obtain an imaged sample, wherein the performing electrophoresis step and the imaging step are operably associated with each other and are automated. Methods of the disclosure may in some embodiments further comprise analyzing the imaged sample with an image analysis system operably associated with the image capture system. Methods of the disclosure may in some embodiments further comprise generating reports of the analyzed image sample.

In some embodiments, a gel electrophoresis system of the disclosure may be configured to run one or more gels at the same time, such as multiple gels at the same time, for example, from two to six gels, such as 2, 3, 4, 5, or 6 gels at the same time.

In some embodiments, systems and methods described herein may be used with electrophoresis gel and buffer systems and methods as described, for example, in U.S. Provisional Patent Application 61/236,293, filed Aug. 24, 2009, the contents of which are hereby incorporated by reference in their entirety. In some embodiments, the device can be used in accordance with the methods and standards and stains described in U.S. Provisional Patent Application No. 61/236,795, filed Aug. 25, 2009, the contents of which are hereby incorporated by reference in their entirety. In some embodiments, the device can be used with gel cassettes and combs configured as described in a U.S. Provisional Patent Application No. 61/237,195, filed Aug. 26, 2009, the contents of which are hereby incorporated by reference in their entirety.

All publications, patents, and patent applications mentioned in this specification are herein incorporated by reference to the same extent as if each individual publication, patent, or patent application was specifically and individually indicated to be incorporated by reference.

While embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure. It is intended that the following claims define the scope of the disclosure and that methods and structures within the scope of these claims and their equivalents be covered thereby.

What is claimed is:

1. A gel processing system comprising:
a gel electrophoresis system; and
a computer system comprising a computer readable medium comprising computer readable instructions, which, when executed by the computer system, are configured to display on a display;
wherein the gel electrophoresis system and the computer system are operably associated with each other.

2. The gel processing system of claim 1, wherein the gel electrophoresis system further comprises:
a gel electrophoresis device;
a gel imaging system;
a gel illumination system;
an image capture system; and
an image analysis system;
wherein the gel electrophoresis device, the gel imaging system, the gel illumination system, the image capture system, and the image analysis system are all housed within a single housing.

3. The system of claim 1, wherein the gel electrophoresis system and the computer system are both housed within a single housing.

4. The system of claim 1, wherein the gel electrophoresis device comprises at least two gel buffer reservoirs, at least two gel holders, and at least one anode and at least one cathode for each of the at least two gel holders.

5. The system of claim 1, wherein the gel illumination system comprises at least one light source configured to illuminate at least one electrophoresis gel when the gel is placed in the gel processing system.

6. The system of claim 5, wherein the at least one light source comprises at least one blue light source.

7. The system of claim 1, wherein the image capture system comprises at least one digital camera.

8. The system of claim 7, wherein the image capture system is configured to provide real time imaging of at least one electrophoresis gel during electrophoresis.

9. A method of performing gel electrophoresis comprising:
performing electrophoresis on at least one labeled sample in a gel processing system comprising:
a gel electrophoresis system; and
a computer system comprising a computer readable medium comprising computer readable instructions, which, when executed by the computer system, are configured to display on a display, wherein the gel electrophoresis system and the computer system are operably associated with each other;
the method comprising:
running a system check on the computer system components;
running a system check on the gel electrophoresis system components and on an at least one gel loaded with the at least one labeled sample in the gel electrophoresis system;
generating at least one method file comprising computer readable instructions and having a plurality of electrophoresis parameters in the computer system; and
performing electrophoresis comprising executing the at least one method file comprising computer readable instructions by the computer system to obtain at least one electrophoresed sample.

10. The method of claim 9, further comprising:
imaging the at least one labeled sample with an image capture system to obtain an imaged sample, wherein the performing electrophoresis step and the imaging step are operably associated with each other and the imaging is executed at least in-part by the computer system.

11. The method of claim 10, further comprising:
analyzing the imaged sample with an image analysis system operably associated with the image capture system, wherein the analyzing is executed at least in-part by the computer system.

12. The method of claim 11, further comprising generating reports of the analyzed image sample, wherein the generating reports is executed at least in-part by the computer system.

13. The method of claim 9, further comprising performing electrophoresis on at least one labeled protein standard simultaneously with the at least one labeled sample.

14. The method of claim 13, further comprising analyzing the electrophoresed sample to determine the molecular weight of the at least one labeled sample.

15. The method of claim 14, further comprising plotting molecular weight of the labeled protein standards in a curve and plotting the data of at least one labeled protein from the at least one labeled sample onto the curve to determine the molecular weight of the at least one labeled protein.

16. The method of claim 9, further comprising analyzing the electrophoresed sample to determine the relative amount of at least one labeled protein comprised in the at least one labeled sample.

17. The method of claim 9, further comprising analyzing the electrophoresed sample to determine an absolute amount of the at least one labeled protein in the sample.

18. The method of claim 9, wherein the method is performed in less than about 30 minutes.

19. The method of claim 9, wherein the method is performed in less than about 15 minutes.

20. A method of performing electrophoresis comprising:
performing electrophoresis on at least one labeled sample in a gel processing system comprising:
a gel electrophoresis system; and
a computer system computer system comprising a computer readable medium comprising computer readable instructions, which, when executed by the computer system, are configured to display on a display, wherein the gel electrophoresis system and the computer system are operably associated with each other,
the method comprising:
setting up at least one gel loaded with the at least one labeled sample in the gel electrophoresis system;
running a system check on the computer system components;
running a system check on the gel electrophoresis components and on the at least one gel loaded with the at least one labeled sample in the gel electrophoresis system;
generating at least a first set of computer readable instructions comprising a plurality of electrophoresis parameters; and
performing electrophoresis comprising executing the first set of computer readable instructions by the computer system interfacing with the gel electrophoresis system to obtain at least one electrophoresed labeled sample.

21. The method of claim 20 further comprising generating at least a second set of computer readable instructions having a plurality of imaging parameters.

22. The method of claim 21, further comprising imaging the at least one electrophoresed labeled sample with an image capture system to obtain an imaged sample, comprising executing the at least second set of computer readable instructions by the computer system interfacing with the image capture system.

23. The method of claim 22 comprising generating at least a third set of computer readable instructions having a plurality of analysis parameters.

24. The method of claim 23, further comprising
analyzing the imaged sample with an image analysis system operably associated with the image capture system, comprising executing the third set of computer readable instructions by the computer system interfacing with the image analysis system.

25. The method of claim 24 comprising generating at least a fourth set of computer readable instructions having a plurality of report generation parameters.

26. The method of claim 25, further comprising
generating reports of the analyzed image sample, comprising executing the at least fourth set of computer readable instructions by the computer system interfacing with electrophoresis system.

27. The method of claim 20, generating file spaces for storing one or more data files relating to the electrophoresis in the computer system.

28. The method of claim 27, wherein the method is performed in less than about 60 minutes.
